(19) United States
(12) Patent Application Publication
(10) Pub. No.: US 2017/0203211 A1
(43) Pub. Date: Jul. 20, 2017

(54) MOTION ANALYSIS METHOD, MOTION ANALYSIS PROGRAM, STORAGE MEDIUM THEREOF, MOTION ANALYSIS APPARATUS, AND MOTION ANALYSIS SYSTEM

(71) Applicant: SEIKO EPSON CORPORATION, Tokyo (JP)

(72) Inventors: Akira KIRYU, Matsumoto-shi (JP); Kenya KODAIRA, Azumino-shi (JP); Tsuyoshi ITO, Suwa-shi (JP); Norihisa HAGIWARA, Hachioji-shi (JP); Kazuhiro ITO, Yokohama-shi (JP); Yamada YOSHIKAZU, Tokyo (JP)

(73) Assignee: SEIKO EPSON CORPORATION, Tokyo (JP)

(21) Appl. No.: 15/388,748

(22) Filed: Dec. 22, 2016

(30) Foreign Application Priority Data
Jan. 15, 2016 (JP) 2016-006347

(51) Int. Cl. A63F 13/40; A63F 13/812; A63B 24/00; A63B 69/36; A63B 71/06; A63F 13/213; A63F 13/211

(52) U.S. Cl. CPC A63F 13/40; A63F 13/213; A63F 13/812; A63F 13/211; A63B 69/3623; A63B 71/06; A63B 69/36; A63B 24/0006; A63F 2300/8011

(57) ABSTRACT

A motion analysis method includes calculating a level of a swing using an output from an inertial sensor measuring the swing of exercise equipment on the basis of a relationship between a first angle formed between a tangential direction of a swing trajectory of a ball hitting portion of the exercise equipment at impact and a target hitting direction, and a second angle formed between a direction orthogonal to a hitting surface of the ball hitting portion at the impact and the target hitting direction.

### BACKGROUND

1. Technical Field

The present invention relates to a motion analysis method, a motion analysis program, a storage medium thereof, a motion analysis apparatus, and a motion analysis system.

2. Related Art

Regarding a motion analysis method and a motion analysis apparatus, there is a technique of detecting an impact which is the moment at which exercise equipment hits a ball, with a motion sensor, and analyzing a swing (refer to JP-A-2014-100341).

However, for example, in golf, a so-called down blow in which the lowest point of a club head during a downswing occurs after impact or a so-called upper blow in which the lowest point thereof occurs before the impact may be differentiated from each other depending on the type of golf club.

However, a swing state in which a swing of exercise equipment at impact is, for example, a down blow or an upper blow cannot be objectively determined.

### SUMMARY

An advantage of some aspects of the invention is to provide a motion analysis method, a motion analysis program, a storage medium thereof, a motion analysis apparatus, and a motion analysis system, capable of objectively determining a swing of exercise equipment at impact.

(1) An aspect of the invention relates to a motion analysis method including calculating a level of a swing using an output from an inertial sensor on the basis of a relationship between a first angle formed between a tangential direction of a swing trajectory of a ball hitting portion of an exercise equipment at impact and a target hitting direction, and a second angle formed between a direction orthogonal to a hitting surface of the ball hitting portion at the impact and the target hitting direction.

According to the aspect of the invention, a level of a swing is calculated on the basis of the first angle corresponding to an attack angle at impact and the second angle corresponding to a face angle of a ball hitting portion with respect to a target hitting direction at impact, and thus it is possible to objectively determine a swing of exercise equipment at impact.

(2) In the aspect of the invention, in a case where an index related to the first angle is a first index, and an index related to the second angle is a second index, the level may be calculated on the basis of the first index and the second index. In this manner, a level can be calculated through positioning of a swing in a two-axis coordinate system formed of the first index and the second index, and thus a swing of exercise equipment at impact can be objectively determined.

(3) In the aspect of the invention, a score may be specified using the first angle and the second angle calculated through measurement on the basis of a table in which a score is added to each region in advance according to a relationship between the first index and the second index, and the score may be calculated as the level. In this manner, since a swing is calculated as a score on the basis of the first index and the second index using the table, it is possible to easily and appropriately perform an objective determination on a swing of exercise equipment at impact.

(4) In the aspect of the invention, in a case where the target hitting direction is set to a +X direction of an X axis, a direction opposite to the gravitational direction is set to a +Z direction of a Z axis, and a direction orthogonal to the X axis and the Z axis is set to be along a Y axis; in a case where, when the Y axis is a rotation axis, a direction in which +Z of the Z axis rotates in the +X direction of the X axis is defined as a first sign, and a sign reverse to the first sign is defined as a second sign, the first and second signs being related to the first angle; and in a case where, when the Z axis is a rotation axis, a direction in which +Y of the Y axis rotates in the +X direction of the X axis is defined as a third sign, and a sign reverse to the third sign is defined as a fourth sign, the third and fourth signs being related to the second angle, in the table, a score may be set for each region in a coordinate system having the first index and the second index as two axes orthogonal to each other, and a score added to the region specified by the first angle and the second angle which are calculated through the measurement may be output.

In this, a level can be calculated on the basis of a positioning region of a swing in a two-axis coordinate system formed of the first index and the second index by taking into consideration a sign of the first angle and a sign of the second angle, and thus a swing of exercise equipment at impact can be objectively determined.

(5) In the aspect of the invention, the first sign may be a negative sign, the second sign may be a positive sign, the third sign may be a negative sign, and the fourth sign may be a positive sign. However, this is only an example. For example, the first and second signs may be replaced with each other, and the third and fourth signs may be replaced with each other. The first to fourth signs may not be positive and negative signs but may be symbols indicating positive and negative signs.

(6) In the aspect of the invention, in a case where a sign of the first angle is the second sign, the lowest score may be calculated. Here, the first sign of the first angle corresponding to an attack angle at impact indicates, for example, a down blow in which the lowest point of a club head during a downswing occurs after the impact, and the second sign thereof indicates an upper blow in which the lowest point thereof occurs before the impact. In an iron club requiring a down blow, if the second sign is determined, the lowest score may be calculated, and thus a swing may be evaluated to be bad. Conversely, in a wood club requiring an upper blow, if the first sign is determined, the lowest score may be calculated, and thus a swing may be evaluated to be bad.

(7) In the aspect of the invention, in a case where a sign of the first angle is the first sign, and a sign of the second angle is the fourth sign, a lower score may be calculated as an absolute value of the second angle becomes greater. The case where a sign of the first angle corresponding to an attack angle is the first sign is a case where a down blow appropriate for an iron club is performed. The case where a sign of the second angle corresponding to a face angle of the ball hitting portion with respect to a target hitting direction at impact is the fourth sign is a case where the face surface tends to be open. In this case, since the face surface tends to be excessively open when an absolute value of the second angle becomes greater, a lower score may be calculated as an absolute value of the second angle becomes greater, and thus a swing may be evaluated to be bad.

(8) In the aspect of the invention, in a case where a sign of the first angle is the first sign, a higher score may be calculated as an absolute value of the first angle becomes smaller, and an absolute value of the second angle becomes smaller. The case where a sign of the first angle corresponding to an attack angle is the first sign is a case where a down blow appropriate for an iron club is performed. In this case, as an absolute value of the first angle becomes smaller, a swing becomes closer to a level blow or an appropriate down blow. As an absolute value of the second angle becomes smaller, the hitting surface of the ball hitting portion becomes closer to a square. Therefore, in these cases, a high score may be calculated according to the first and second angles, and thus a swing may be evaluated to be good.

(9) In the aspect of the invention, in a case where a sign of the first angle is the first sign, and a sign of the second angle is the third sign, a lower score may be calculated as an absolute value of the second angle becomes greater. The case where a sign of the first angle corresponding to an attack angle is the first sign is a case where a down blow appropriate for an iron club is performed. The case where a sign of the second angle corresponding to a face angle of the ball hitting portion with respect to a target hitting direction at impact is the third sign is a case where the face surface tends to be closed. In this case, since the face surface tends to be excessively closed when an absolute value of the second angle becomes greater, a lower score may be calculated as an absolute value of the second angle becomes greater, and thus a swing may be evaluated to be bad.

(10) In the aspect of the invention, the motion analysis method may further include outputting information regarding the level. When information regarding the level is output, it is thus possible to perform a notification of the level of a swing.

(11) In the aspect of the invention, the motion analysis method may further include performing diagnosis on the level; and outputting diagnosis information based on the diagnosis. In this manner, it is possible to perform a notification of a swing diagnosis result.

(12) In the aspect of the invention, the motion analysis method may further include outputting a practice method on the basis of the diagnosis information. In this manner, it is possible to output a practice method according to a swing diagnosis result.

(13) Another aspect of the invention relates to a motion analysis program causing a computer to execute a procedure of calculating a level of a swing using an output from an inertial sensor which measures a swing of exercise equipment on the basis of a relationship between a first angle formed between a tangential direction of a swing trajectory of a ball hitting portion of the exercise equipment at impact and a target hitting direction, and a second angle formed between a direction orthogonal to a hitting surface of the ball hitting portion at the impact and the target hitting direction.

The motion analysis program according to the aspect of the invention may be stored in a storage device of a motion analysis apparatus performing the motion analysis method according to the aspect of the invention, or may be installed in the storage device of the motion analysis apparatus from a server or a recording medium. In this manner, the program can execute the motion analysis method according to the aspect of the invention.

(14) Another aspect of the invention relates to a recording medium recording a motion analysis program causing a computer to execute a procedure of calculating a level of a swing using an output from an inertial sensor which measures a swing of exercise equipment on the basis of a relationship between a first angle formed between a tangential direction of a swing trajectory of a ball hitting portion of the exercise equipment at impact and a target hitting direction, and a second angle formed between a direction orthogonal to a hitting surface of the ball hitting portion at the impact and the target hitting direction.

The recording medium according to the aspect of the invention may be used as a storage device of a motion analysis apparatus performing the motion analysis method according to the aspect of the invention, and the motion analysis program may be installed in the storage device of the motion analysis apparatus from the recording medium.

(15) Another aspect of the invention relates to a motion analysis apparatus including a first angle calculation unit that calculates a first angle formed between a tangential direction of a swing trajectory of a ball hitting portion of an exercise equipment at impact and a target hitting direction, using an output from an inertial sensor which measures a swing of the exercise equipment; a second angle calculation unit that calculates a second angle formed between a direction orthogonal to a hitting surface of the ball hitting portion at the impact and the target hitting direction using an output from the inertial sensor; and a level calculation unit that calculates a level of the swing on the basis of a relationship between the first angle and the second angle.

According to the motion analysis apparatus of the aspect of the invention, it is possible to appropriately perform the motion analysis method of the aspect of the invention.

(16) Another aspect of the invention relates to a motion analysis system including the motion analysis apparatus; and an inertial sensor.

According to the motion analysis system of the aspect of the invention, it is possible to appropriately perform the motion analysis method of the aspect of the invention.

### BRIEF DESCRIPTION OF THE DRAWINGS

The invention will be described with reference to the accompanying drawings, wherein like numbers reference like elements.

FIG. 1 is a diagram illustrating a configuration example of a motion analysis system of the present embodiment.

FIG. 2 is a diagram illustrating a sensor unit and a swing analysis apparatus.

FIG. 3 is a diagram illustrating examples of a position at which and a direction in which the sensor unit is attached.

FIG. 4 is a diagram illustrating procedures of actions performed by a user until the user hits a ball.

FIG. 5 is a diagram illustrating an example of an input screen of physical information and golf club information.

FIG. 6 is a diagram illustrating a swing action.

FIG. 7 is a diagram illustrating an example of a selection screen of swing analysis data.

FIG. 8 is a diagram illustrating an example of an editing screen of input data which is a swing diagnosis target.

FIG. 9 is a diagram illustrating an example of a swing diagnosis screen.

FIG. 10 is a diagram illustrating configuration examples of the sensor unit and a swing analysis apparatus.

FIG. 11 is a plan view in which a golf club and the sensor unit are viewed from a negative side of an X axis during standing still of the user.

FIG. 12 is a graph illustrating examples of temporal changes of three-axis angular velocities.

FIG. 13 is a graph illustrating a temporal change of a combined value of the three-axis angular velocities.

FIG. 14 is a graph illustrating a temporal change of a derivative of the combined value.

FIG. 15 is a diagram illustrating a shaft plane and a Hogan plane.

FIG. 16 is a view in which a sectional view of the shaft plane which is cut in a YZ plane is viewed from the negative side of the X axis.

FIG. 17 is a view in which a sectional view of the Hogan plane which is cut in the YZ plane is viewed from the negative side of the X axis.

FIG. 18 is a diagram for explaining a face angle and a club path (incidence angle).

FIG. 19 is a diagram illustrating an example of a temporal change of a shaft axis rotation angle from swing starting (backswing starting) to impact.

FIG. 20 is a diagram illustrating an example of a temporal change of a speed of a grip in a downswing.

FIG. 21 is a diagram for explaining definition of an attack angle (first angle) of a ball hitting portion at impact.

FIG. 22 is a flowchart illustrating examples of procedures of a swing analysis process (swing analysis method).

FIG. 23 is a diagram illustrating a configuration example of a swing diagnosis apparatus.

FIG. 24 is a diagram illustrating relationships among the shaft plane and the Hogan plane, and a plurality of regions.

FIG. 25 is a diagram illustrating an example of a V zone score table.

FIG. 26 is a diagram illustrating an example of a rotation score table.

FIG. 27 is a diagram illustrating an example of an impact score table.

FIG. 28 is a diagram illustrating an example of a down blow score table.

FIG. 29 is a diagram illustrating an example of an upper blow score table.

FIG. 30 is a diagram illustrating an example of a swing efficiency score table.

FIG. 31 is a flowchart illustrating examples of procedures of a process performed by the swing analysis apparatus in relation to a swing diagnosis process.

FIG. 32 is a flowchart illustrating examples of procedures of the swing diagnosis process (swing diagnosis method).

FIG. 33 is a flowchart illustrating examples of procedures of a process of calculating scores and a total score of a plurality of items.

FIG. 34 is a diagram illustrating an example of a swing diagnosis screen.

FIG. 35 is a diagram illustrating an example of a lesson screen.

FIG. 36 is a diagram illustrating an example in which the motion analysis apparatus is configured using a head mounted display.

FIG. 37 is a diagram illustrating an example in which the motion analysis apparatus is configured using a wrist type terminal.

### DESCRIPTION OF EXEMPLARY EMBODIMENTS

Hereinafter, preferred embodiments of the invention will be described with reference to the drawings. The embodiments described below are not intended to improperly limit the content of the invention disclosed in the appended claims. In addition, all constituent elements described below are not essential constituent elements of the invention.

### 1. Motion Analysis System

### 1-1. Configuration of Motion Analysis System

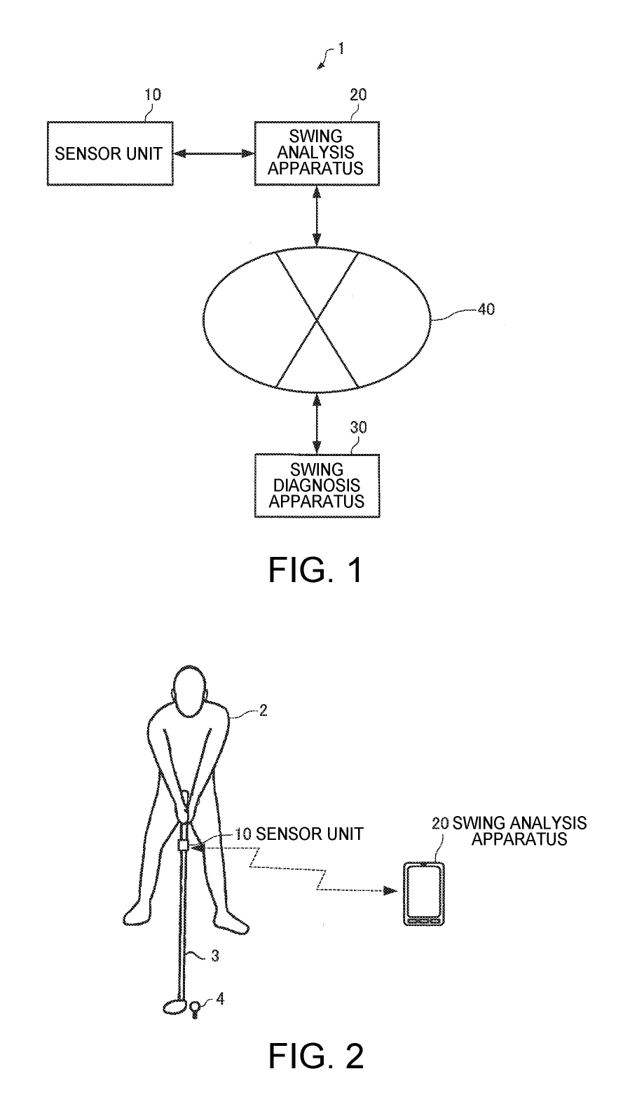

Hereinafter, analysis of a golf swing will be described as an example of motion analysis. FIG. 1 is a diagram illustrating a configuration example of a motion analysis system of the present embodiment. As illustrated in FIG. 1, a motion analysis system 1 of the present embodiment is configured to include a sensor unit (an example of an inertial sensor) 10, and a swing analysis apparatus (an example of a motion analysis apparatus) 20. Communication between the sensor unit 10 and the swing analysis apparatus 20 may be wireless communication, and may be wired communication. The swing analysis apparatus 20 is implemented by various information terminals (client terminals) including not only a personal computer, but also a portable apparatus such as a smart phone or a tablet PC, or a wearable terminal such as head mounted display (HMD) or a wrist apparatus.

The motion analysis system 1 may be configured to include a swing diagnosis apparatus 30 separately from the swing analysis apparatus 20. However, the swing diagnosis apparatus 30 may be included in the swing analysis apparatus 20. The swing diagnosis apparatus 30 may be implemented by a server which processes a request from the swing analysis apparatus 20. The swing analysis apparatus 20 and the swing diagnosis apparatus 30 may be connected to each other via a network 40. The network 40 may be a wide area network (WAN) such as the Internet, and may be a local area network (LAN). The swing analysis apparatus 20 and the swing diagnosis apparatus 30 may communicate with each other through, for example, near field communication or wired communication, without using the network 40.

The sensor unit 10 can measure acceleration in each axial direction of three axes and angular velocity about each of the three axes, and is attached to a golf club 3 as illustrated in FIG. 2.

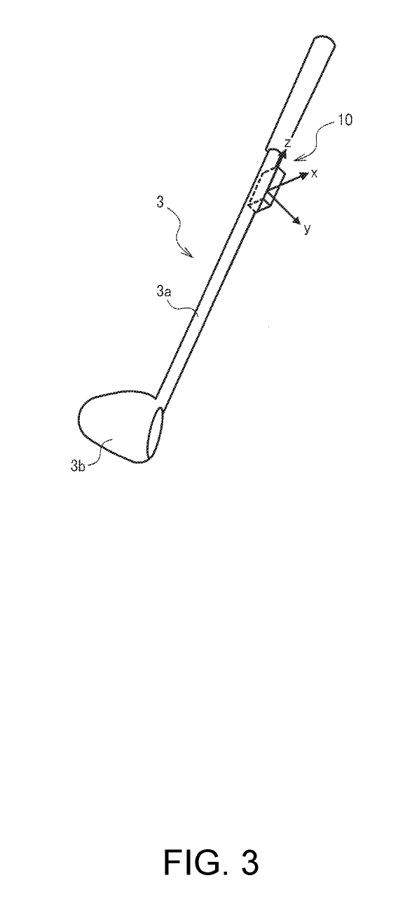

As illustrated in FIG. 3, the sensor unit 10 is attached to the golf club 3 so as to match three detection axes (an x axis, a y axis, and a z axis) intersecting (ideally, orthogonal to) each other. In FIG. 3, the sensor unit 10 is attached to a part of a shaft 3a so that, for example, the z axis matches a longitudinal direction of the shaft 3a of the golf club 3 (a longitudinal direction of the golf club 3), and, for example, the x axis matches a target direction of a hit ball (target hitting direction). Preferably, the sensor unit 10 is attached to a position close to a grip to which impact during ball hitting is hardly forwarded and a centrifugal force is hardly applied during a swing. The shaft 3a is a shaft portion other than a head (ball hitting portion) 3b of the golf club 3 and also includes the grip. However, the sensor unit 10 may be attached to a part (for example, the hand or a glove) of a user 2, and may be attached to an accessory such as a wristwatch.

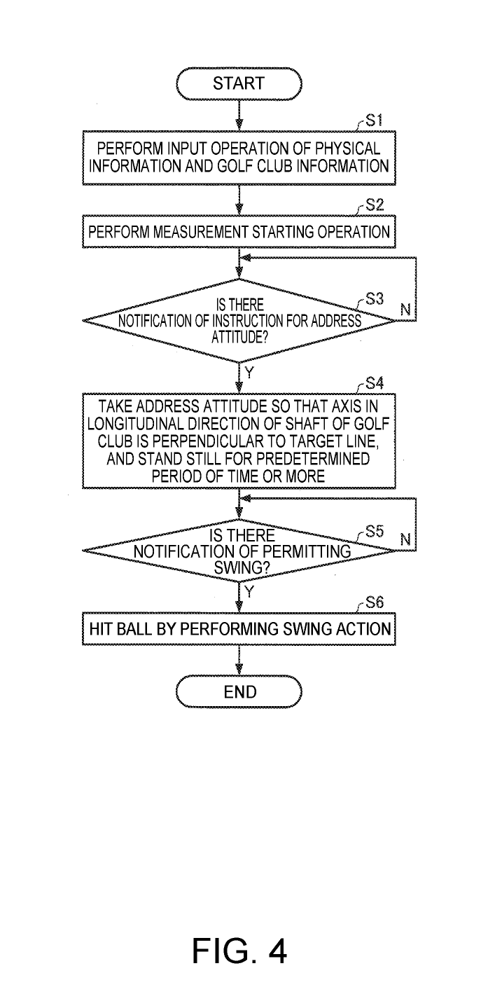

The user 2 performs a swing action for hitting a golf ball 4 or a swing action through a practice swing according to predefined procedures. FIG. 4 is a diagram illustrating procedures of actions performed by the user 2 until the user hits the ball in the present embodiment. As illustrated in FIG. 4, first, the user 2 performs an input operation of physical information of the user 2, information (golf club information) regarding the golf club 3 used by the user 2, and the like via the swing analysis apparatus 20 (step S1).

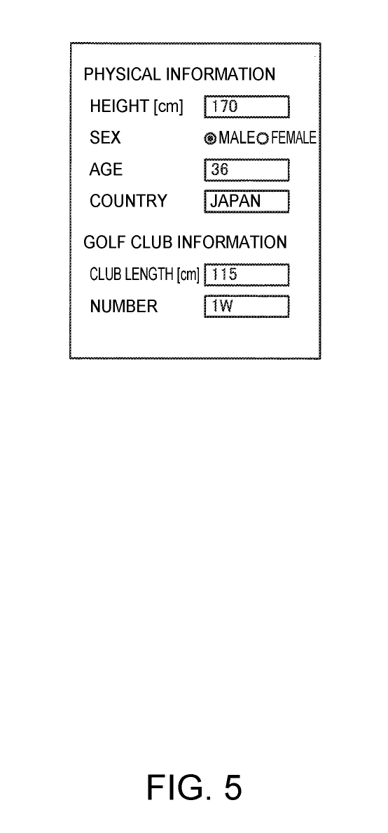

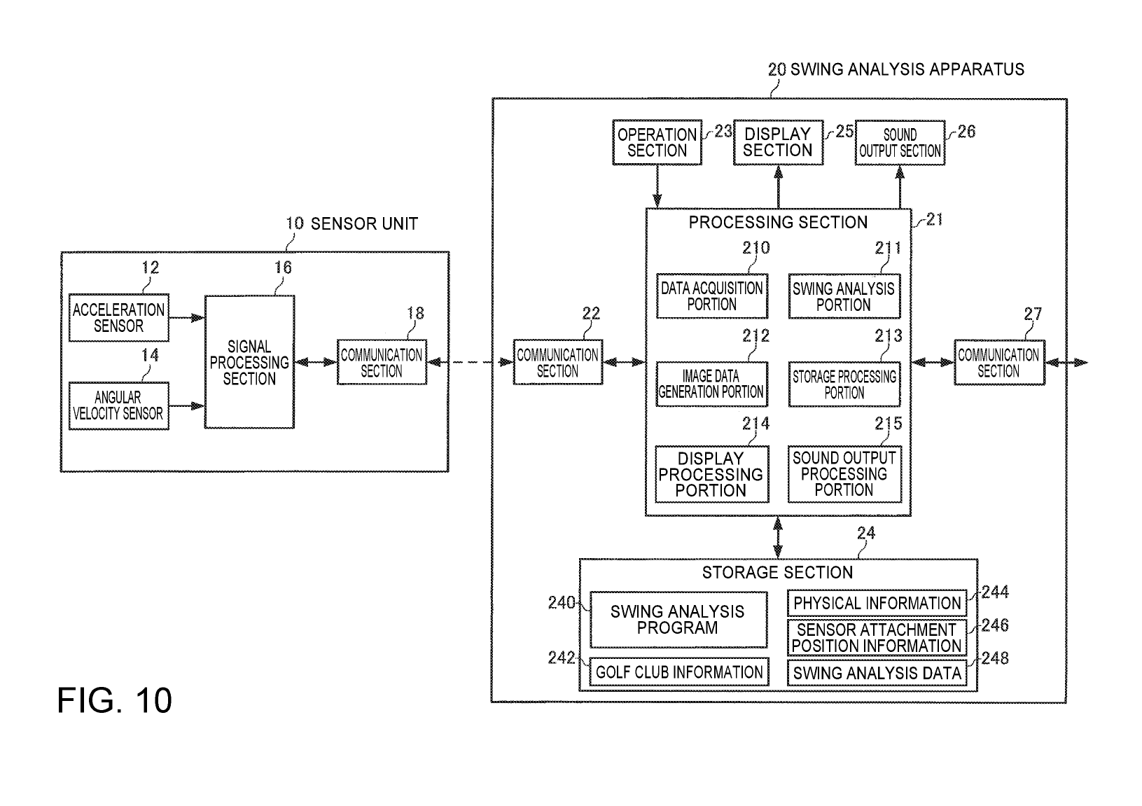

FIG. 5 is a diagram illustrating an example of an input screen of physical information and golf club information, displayed on a display section 25 (refer to FIG. 10) of the swing analysis apparatus 20. In step S1 in FIG. 4, the user 2 inputs physical information such as a height, sex, age, and country, and inputs golf club information such as a club length (a length of the shaft 3a), and a club number on the input screen illustrated in FIG. 5. Information included in the physical information is not limited thereto, and, the physical information may include, for example, at least one of information regarding a length of the arms and a length of the legs instead of or along with the height. Similarly, information included in the golf club information is not limited thereto, and, for example, the golf club information may not include at least one of information regarding the club length and the club number, and may include other information.

Next, the user 2 performs a measurement starting operation (an operation for starting measurement in the sensor unit 10) via the swing analysis apparatus 20 (step S2). After receiving a notification (for example, a notification using a voice) of giving an instruction for taking an address attitude (a basic attitude before starting a swing) from the swing analysis apparatus 20 (Y in step S3), the user 2 takes an address attitude so that the axis in the longitudinal direction of the shaft 3a of the golf club 3 is perpendicular to a target line (target hit ball direction), and stands still (step S4). Next, the user 2 receives a notification (for example, a notification using a voice) of permitting a swing from the swing analysis apparatus 20 (Y in step S5), and then hits the golf ball 4 by performing a swing action (step S6). The present embodiment is not necessarily limited to ball hitting, and is also applicable to a practice swing, and may have a function of detecting a timing corresponding to ball hitting.

If the user 2 performs the measurement starting operation in step S2 in FIG. 4, the swing analysis apparatus 20 transmits a measurement starting command to the sensor unit 10, and the sensor unit 10 receives the measurement starting command and starts measurement of three-axis accelerations and three-axis angular velocities. The sensor unit 10 measures three-axis accelerations and three-axis angular velocities in a predetermined cycle (for example, 1 ms), and sequentially transmits the measured data to the swing analysis apparatus 20.

The swing analysis apparatus 20 notifies the user 2 of permission of swing starting, shown in step S5 in FIG. 4, and then analyzes the swing action (step S6 in FIG. 4) in which the user 2 has hit the ball using the golf club 3 on the basis of measured data from the sensor unit 10.

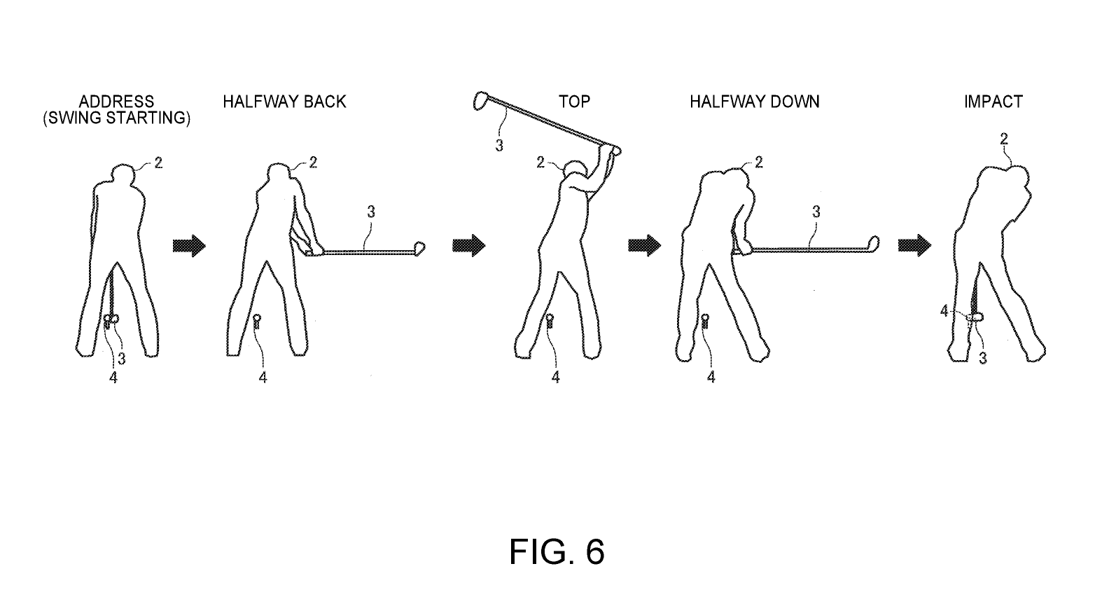

As illustrated in FIG. 6, the swing action performed by the user 2 in step S6 in FIG. 4 includes an action reaching impact (ball hitting) at which the golf ball 4 is hit through respective states of halfway back at which the shaft of the golf club 3 becomes horizontal during a backswing after starting a swing (backswing), a top at which the swing changes from the backswing to a downswing, and halfway down at which the shaft of the golf club 3 becomes horizontal during the downswing. The swing analysis apparatus 20 generates swing analysis data including information regarding a time point (date and time) at which the swing is performed, identification information or the sex of the user 2, the type of golf club 3, and an analysis result of the swing action, and transmits the swing analysis data to the swing diagnosis apparatus 30 via a network 40 (refer to FIG. 1).

The swing diagnosis apparatus 30 receives the swing analysis data transmitted by the swing analysis apparatus 20 via the network 40, and preserves the swing analysis data. Therefore, when the user 2 performs a swing action according to the procedures illustrated in FIG. 4, the swing analysis data generated by the swing analysis apparatus 20 is preserved in the swing diagnosis apparatus 30, and thus a swing analysis data list is built.

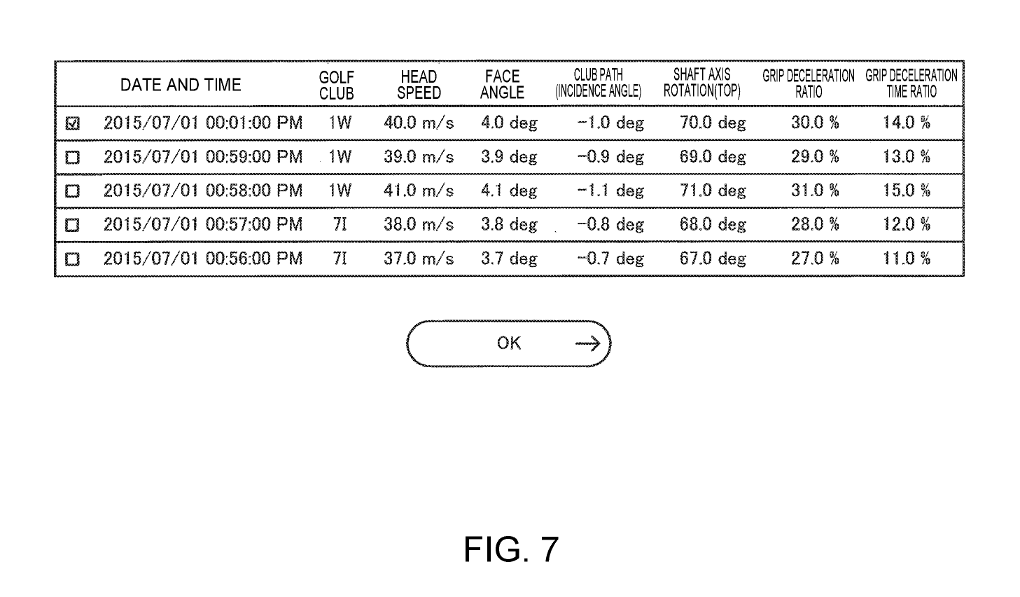

In the present embodiment, if the user 2 activates a swing diagnosis application via an operation section 23 (refer to FIG. 10) of the swing analysis apparatus 20, the swing analysis apparatus 20 performs communication with the swing diagnosis apparatus 30, and, for example, a selection screen of swing analysis data as illustrated in FIG. 7 is displayed on the display section 25 of the swing analysis apparatus 20. The selection screen includes a time point (date and time), the type of golf club which has been used, and some index values as analysis results of a swing, with respect to each item of swing analysis data regarding the user 2 included in the swing analysis data list preserved in the swing diagnosis apparatus 30.

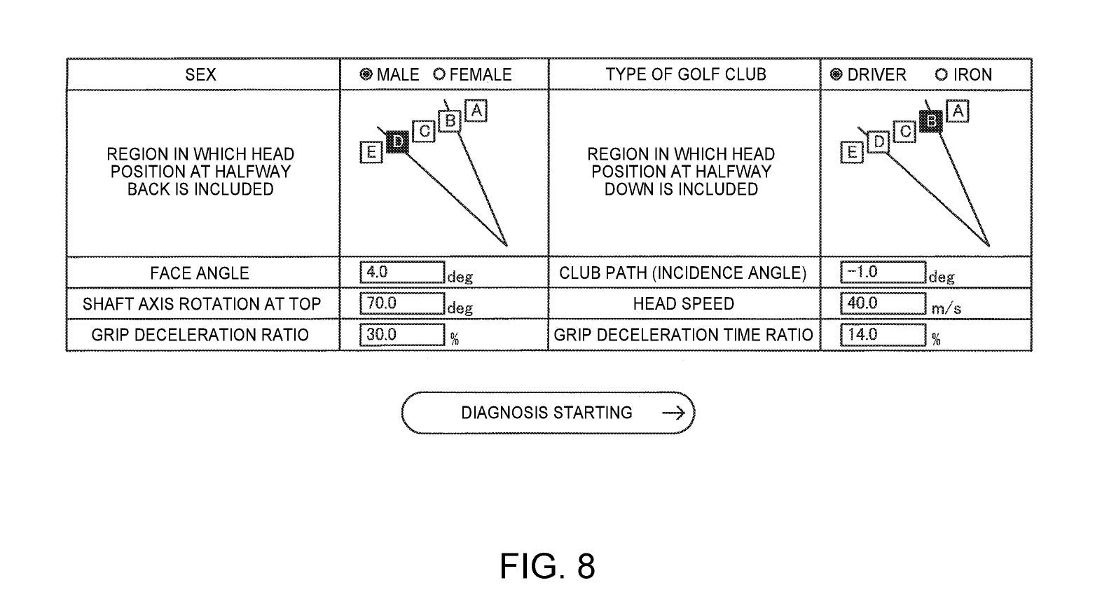

A checkbox correlated with each item of swing analysis data is located at a left end (a left end on the drawing surface) of the selection screen illustrated in FIG. 7, and the user 2 checks any one of the checkboxes by operating the swing analysis apparatus 20, and then presses an OK button located on a lower part of the selection screen. Consequently, the swing analysis apparatus 20 performs communication with the swing diagnosis apparatus 30, for example, an editing screen of input data which is a swing diagnosis target, as illustrated in FIG. 8, is displayed on the display section 25 of the swing analysis apparatus 20, with respect to the swing analysis data correlated with the checked checkbox on the selection screen illustrated in FIG. 7.

The input data editing screen illustrated in FIG. 8 includes values obtained on the basis of the selected swing analysis data as initial values with respect to the sex, the type of golf club (either of a driver or an iron), and each index of a swing. Meanings or calculation methods of the respective indexes (a region in which a head position at halfway back is included, a region in which a head position at halfway down is included, a face angle, a club path (incidence angle), a shaft axis rotation angle at top, a head speed, a grip deceleration ratio, and a grip deceleration time ratio) included in the input data editing screen illustrated in FIG. 8 will be described later.

The input data formed of the sex, the type of golf club, and the respective index values in the input data editing screen illustrated in FIG. 8 can be edited. The user 2 does not edit the input data or edits the input data via the operation section 23 (refer to FIG. 10) of the swing analysis apparatus 20, and then presses a diagnosis starting button located on a lower part of the input data editing screen. Consequently, the swing analysis apparatus 20 transmits the input data at the time of the diagnosis starting button being pressed to the swing diagnosis apparatus 30.

The swing diagnosis apparatus 30 receives the input data, and performs calculation of levels of a plurality of items using the input data. For example, the swing diagnosis apparatus 30 may calculate a level of each of five items such as a “V zone”, “rotation”, “impact”, a “down blow” or an “upper blow”, and “swing efficiency” illustrated in the radar chart of FIG. 8, as 5 points maximum. Meanings or calculation methods of the five items will be described later. The swing diagnosis apparatus 30 may calculate a total score of a swing using the respective levels of the five items. The swing diagnosis apparatus 30 transmits information regarding the calculated levels and total score of the plurality of items to the swing analysis apparatus 20. The “levels” may be represented by, for example, “1, 2, 3, . . . ”, “A, B, C, . . . ”, “O, X, Δ, . . . ”, and may be represented by scores.

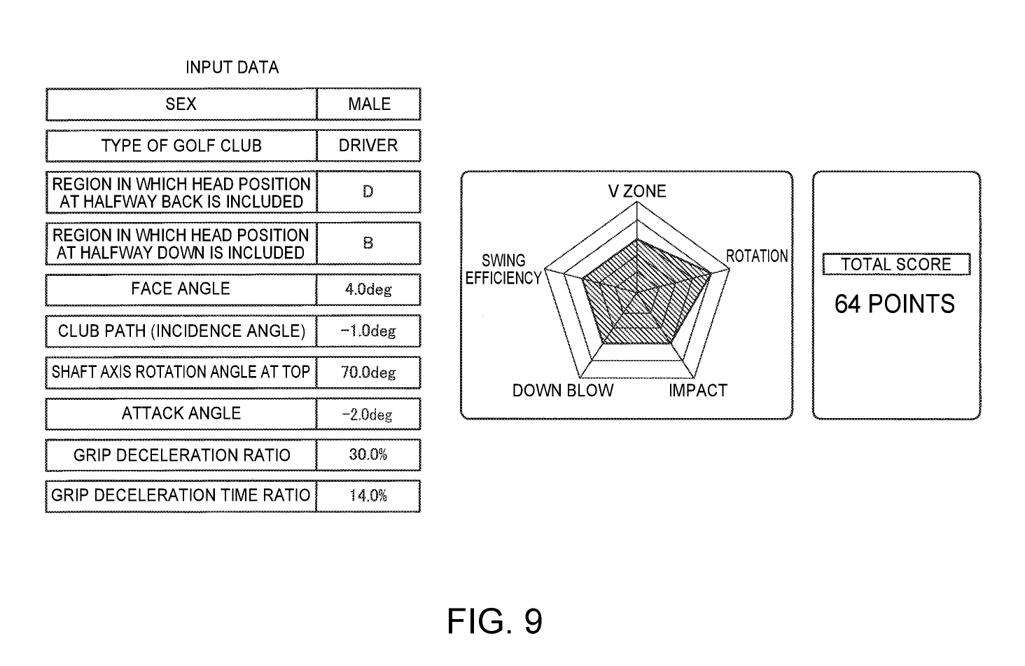

The swing analysis apparatus 20 receives the information regarding levels and total score of the plurality of items, and displays, for example, a swing diagnosis screen as illustrated in FIG. 9 on the display section 25. The swing diagnosis screen illustrated in FIG. 9 includes input data information on a left part thereof. The input data information is input data at the time of the diagnosis starting button being pressed in the input data editing screen illustrated in FIG. 8, that is, data information used for diagnosis of the swing (that is, calculation of the levels and the total score of the five items) in the swing diagnosis apparatus 30. The swing diagnosis screen illustrated in FIG. 9 includes a radar chart indicating scores as the levels of the five items on the central part thereof, and includes information regarding the total score on a right part thereof.

The user 2 can understand levels and a total score of the plurality of items as diagnosis results for the input data on the left part on the basis of the swing diagnosis screen illustrated in FIG. 9. Particularly, if the user 2 presses the diagnosis starting button without editing the input data on the input data editing screen illustrated in FIG. 8, the user can understand a strong point or a weak point in the user's swing on the basis of the swing diagnosis screen illustrated in FIG. 9. On the other hand, if the user 2 edits the input data and presses the diagnosis starting button on the input data editing screen illustrated in FIG. 8, the user can understand which index is improved to what extent in order to overcome the weak point. Hereinafter, a description will be made of an example in which “levels” of a plurality of items are represented by “scores”, but, needless to say, the example can be easily replaced with an example of the levels being expressed by “1, 2, 3, . . . ”, “A, B, C, . . . ”, “O, X, Δ”, or the like.

### 1-2. Configurations of Sensor Unit and Swing Analysis Apparatus

FIG. 10 is a diagram illustrating configuration examples of the sensor unit 10 and the swing analysis apparatus 20. As illustrated in FIG. 10, in the present embodiment, the sensor unit 10 is configured to include an acceleration sensor 12, an angular velocity sensor 14, a signal processing section 16, and a communication section 18. However, the sensor unit 10 may have a configuration in which some of the constituent elements are deleted or changed as appropriate, or may have a configuration in which other constituent elements are added thereto.

The acceleration sensor 12 measures respective accelerations in three axial directions which intersect (ideally, orthogonal to) each other, and outputs digital signals (acceleration data) corresponding to magnitudes and directions of the measured three-axis accelerations.

The angular velocity sensor 14 measures respective angular velocities in three axial directions which intersect (ideally, orthogonal to) each other, and outputs digital signals (angular velocity data) corresponding to magnitudes and directions of the measured three-axis angular velocities.

The signal processing section 16 receives the acceleration data and the angular velocity data from the acceleration sensor 12 and the angular velocity sensor 14, respectively, adds time information thereto, stores the data in a storage portion (not illustrated), adds time information to the stored measured data (acceleration data and angular velocity data) so as to generate packet data conforming to a communication format, and outputs the packet data to the communication section 18.

Ideally, the acceleration sensor 12 and the angular velocity sensor 14 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 16 performs a process of converting the acceleration data and the angular velocity data into data in the xyz coordinate system using a correction parameter which is calculated in advance according to the installation angle errors.

The signal processing section 16 may perform a process of correcting the temperatures of the acceleration sensor 12 and the angular velocity sensor 14. Alternatively, the acceleration sensor 12 and the angular velocity sensor 14 may have a temperature correction function.

The acceleration sensor 12 and the angular velocity sensor 14 may output analog signals, and, in this case, the signal processing section 16 may A/D convert an output signal from the acceleration sensor 12 and an output signal from the angular velocity sensor 14 so as to generate measured data (acceleration data and angular velocity data), and may generate communication packet data using the data.

The communication section 18 performs a process of transmitting packet data received from the signal processing section 16 to the swing analysis apparatus 20, or a process of receiving a control command such as a measurement start command from the swing analysis apparatus 20 and sending the control command to the signal processing section 16. The signal processing section 16 performs various processes corresponding to control commands.

As illustrated in FIG. 10, in the present embodiment, the swing analysis apparatus 20 is configured to include a processing section 21, a communication section 22, an operation section 23, a storage section 24, a display section 25, a sound output section 26, and a communication section 27. However, the swing analysis apparatus 20 may have a configuration in which some of the constituent elements are deleted or changed as appropriate, or may have a configuration in which other constituent elements are added thereto.

The communication section 22 performs a process of receiving packet data transmitted from the sensor unit 10 and sending the packet data to the processing section 21, or a process of transmitting a control command from the processing section 21 to the sensor unit 10.

The operation section 23 performs a process of acquiring operation data from the user 2 and sending the operation data to the processing section 21. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21 performing various calculation processes or a control process, or various programs or data for realizing application functions.

In the present embodiment, the storage section 24 stores a swing analysis program 240 which is read by the processing section 21 and executes a swing analysis process. The swing analysis program 240 may be stored in a nonvolatile recording medium (computer readable recording medium) in advance, or the swing analysis program 240 may be received from a server (not illustrated) or the swing diagnosis apparatus 30 by the processing section 21 via a network, and may be stored in the storage section 24.

In the present embodiment, the storage section 24 stores golf club information 242, physical information 244, sensor attachment position information 246, and swing analysis data 248. For example, the user 2 may operate the operation section 23 so as to input specification information regarding the golf club 3 (for example, at least some information such as information regarding a length of the shaft, a position of the centroid thereof, a lie angle, a face angle, a loft angle, and the like) from the input screen illustrated in FIG. 5, and the input specification information may be used as the golf club information 242. Alternatively, in step S1 in FIG. 4, the user 2 may sequentially input type numbers of the golf club 3 (alternatively, selects a type number from a type number list) so that specification information for each type number is stored in the storage section 24 in advance. In this case, specification information of an input type number may be used as the golf club information 242.

For example, the user 2 may input physical information by operating the operation section 23 from the input screen illustrated in FIG. 5, and the input physical information may be used as the physical information 244. For example, in step S1 in FIG. 4, the user 2 may input an attachment position of the sensor unit 10 and a distance to the grip of the golf club 3 by operating the operation section 23, and the input distance information may be used as the sensor attachment position information 246. Alternatively, the sensor unit 10 may be attached at a defined predetermined position (for example, a distance of 20 cm from the grip), and thus information regarding the predetermined position may be stored as the sensor attachment position information 246 in advance.

The swing analysis data 248 is data including information regarding a swing action analysis result in the processing section 21 (swing analysis portion 211) along with a time point (date and time) at which a swing was performed, identification information or the sex of the user 2, and the type of golf club 3.

The storage section 24 is used as a work area of the processing section 21, and temporarily stores data which is input from the operation section 23, results of calculation executed by the processing section 21 according to various programs, and the like. The storage section 24 may store data which is required to be preserved for a long period of time among data items generated through processing of the processing section 21.

The display section 25 displays a processing result in the processing section 21 as text, a graph, a table, animation, and other images. The display section 25 may be, for example, a CRT, an LCD, a touch panel type display, and a head mounted display (HMD). A single touch panel type display may realize functions of the operation section 23 and the display section 25.

The sound output section 26 outputs a processing result in the processing section 21 as a sound such as a voice or a buzzer sound. The sound output section 26 may be, for example, a speaker or a buzzer.

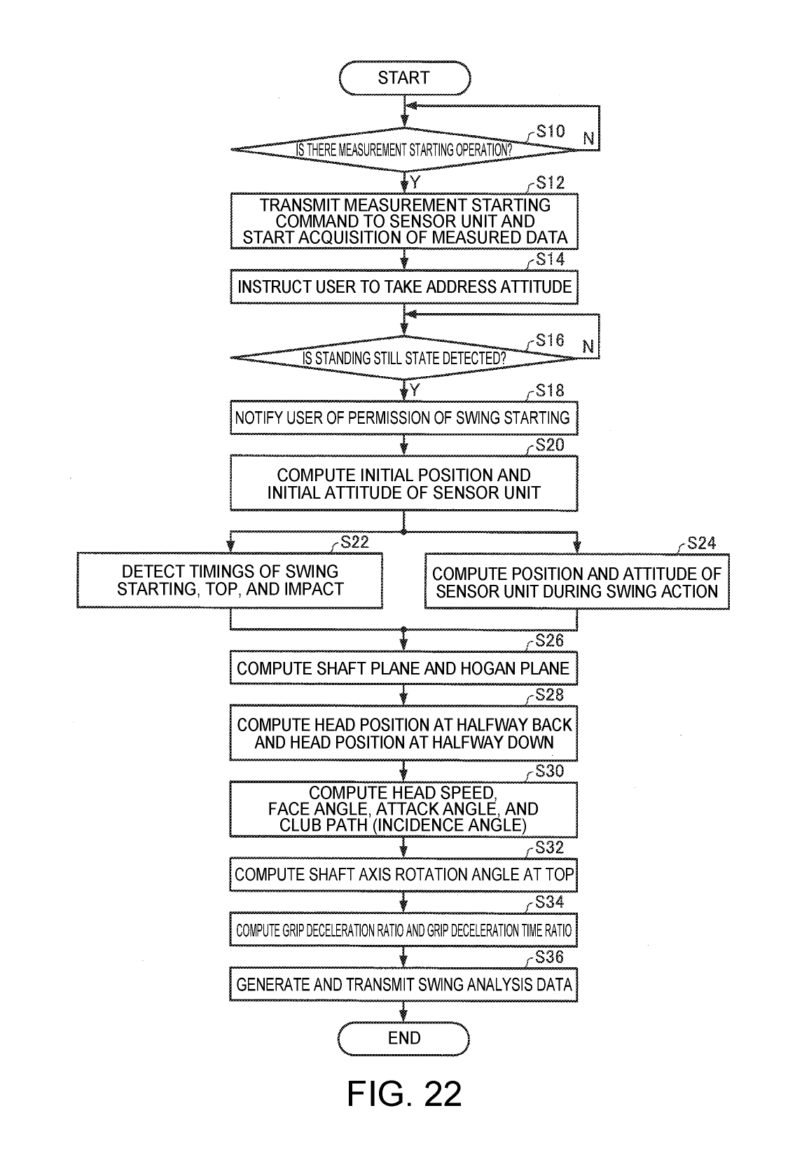

The communication section 27 performs data communication with a communication section 32 (refer to FIG. 22) of the swing diagnosis apparatus 30 via the network 40. For example, the communication section 27 performs a process of receiving the swing analysis data 248 from the processing section 21 after a swing analysis process is completed, and transmitting the swing analysis data to the communication section 32 of the swing diagnosis apparatus 30. For example, the communication section 27 performs a process of receiving information required to display the selection screen illustrated in FIG. 7 from the communication section 32 of the swing diagnosis apparatus 30 and transmitting the information to the processing section 21, and a process of receiving selected information on the selection screen illustrated in FIG. 7 from the processing section 21 and transmitting the selected information to the communication section 32 of the swing diagnosis apparatus 30. For example, the communication section 27 performs a process of receiving information required to display the input data editing screen illustrated in FIG. 8 from the communication section 32 of the swing diagnosis apparatus 30, and transmitting the information to the processing section 21. For example, the communication section 27 performs a process of receiving input data at the time of the diagnosis starting button being pressed on the input data editing screen illustrated in FIG. 8 from the processing section 21, and transmitting the input data to the communication section 32 of the swing diagnosis apparatus 30. For example, the communication section 27 performs a process of receiving information (diagnosis result information (scores or a total score of a plurality of items) based on the input data) required to display the swing diagnosis screen illustrated in FIG. 9 from the communication section 32 of the swing diagnosis apparatus 30, and transmitting the information to the processing section 21.

The processing section 21 performs a process of transmitting a control command to the sensor unit 10 via the communication section 22, or various computation processes on data which is received from the sensor unit 10 via the communication section 22, according to various programs. The processing section 21 performs a process of reading the swing analysis data 248 from the storage section 24, and transmitting the swing analysis data to the swing diagnosis apparatus 30 via the communication section 27, according to various programs. The processing section 21 performs a process of transmitting various pieces of information to the swing diagnosis apparatus 30 via the communication section 27, and displaying various screens (the respective screens illustrated in FIGS. 7, 8 and 9) on the basis of the information received from the swing diagnosis apparatus 30, according to various programs. The processing section 21 performs other various control processes.

Particularly, in the present embodiment, by executing the swing analysis program 240, the processing section 21 functions as a data acquisition portion 210, a swing analysis portion 211, an image data generation portion 212, a storage processing portion 213, a display processing portion 214, and a sound output processing portion 215, and performs a process (swing analysis process) of analyzing a swing action of the user 2.

The data acquisition portion 210 performs a process of receiving packet data which is received from the sensor unit 10 by the communication section 22, acquiring time information and measured data from the received packet data, and sending the time information and the measured data to the storage processing portion 213. The data acquisition portion 210 performs a process of receiving the information required to display the various screens (the respective screens illustrated in FIGS. 7, 8 and 9), received from the swing diagnosis apparatus 30 by the communication section 27, and transmitting the information to the image data generation portion 212.

The storage processing portion 213 performs read/write processes of various programs or various data for the storage section 24. The storage processing portion 213 performs a process of storing the time information and the measured data received from the data acquisition portion 210 in the storage section 24 in correlation with each other, or a process of storing various pieces of information calculated by the swing analysis portion 211, the swing analysis data 248, or the like in the storage section 24.

The swing analysis portion 211 performs a process of analyzing a swing action of the user 2 using the measured data (the measured data stored in the storage section 24) output from the sensor unit 10, the data from the operation section 23, or the like, so as to generate the swing analysis data 248 including a time point (date and time) at which the swing was performed, identification information or the sex of the user 2, the type of golf club 3, and information regarding a swing action analysis result. Particularly, in the present embodiment, the swing analysis portion 211 calculates a value of each index of the swing as at least some of the information regarding the swing action analysis result.

The image data generation portion 212 performs a process of generating image data corresponding to an image displayed on the display section 25. For example, the image data generation portion 212 generates image data corresponding to the selection screen illustrated in FIG. 7, the input data editing screen illustrated in FIG. 8, and the swing diagnosis screen illustrated in FIG. 9, on the basis of various pieces of information received by the data acquisition portion 210.

The display processing portion 214 performs a process of displaying various images (including text, symbols, and the like in addition to an image corresponding to the image data generated by the image data generation portion 212) on the display section 25. For example, the display processing portion 214 displays the selection screen illustrated in FIG. 7, the input data editing screen illustrated in FIG. 8, the swing diagnosis screen illustrated in FIG. 9, and the like, on the display section 25, on the basis of the image data generated by the image data generation portion 212. For example, the image data generation portion 212 may display an image, text, or the like for notifying the user 2 of permission of swing starting on the display section 25 in step S5 in FIG. 4. For example, the display processing portion 214 may display text information such as text or symbols indicating an analysis result in the swing analysis portion 211 on the display section 25 automatically or in response to an input operation performed by the user 2 after a swing action of the user 2 is completed. Alternatively, a display section may be provided in the sensor unit 10, and the display processing portion 214 may transmit image data to the sensor unit 10 via the communication section 22, and various images, text, or the like may be displayed on the display section of the sensor unit 10.

The sound output processing portion 215 performs a process of outputting various sounds (including voices, buzzer sounds, and the like) from the sound output section 26. For example, the sound output processing portion 215 may output a sound for notifying the user 2 of permission of swing starting from the sound output section 26 in step S5 in FIG. 4. For example, the sound output processing portion 215 may output a sound or a voice indicating an analysis result in the swing analysis portion 211 from the sound output section 26 automatically or in response to an input operation performed by the user 2 after a swing action of the user 2 is completed. Alternatively, a sound output section may be provided in the sensor unit 10, and the sound output processing portion 215 may transmit various items of sound data or voice data to the sensor unit 10 via the communication section 22, and may output various sounds or voices from the sound output section of the sensor unit 10.

A vibration mechanism may be provided in the swing analysis apparatus 20 or the sensor unit 10, and various pieces of information may be converted into vibration pieces of information by the vibration mechanism so as to be presented to the user 2.

### 1-3. Swing Analysis Process

In the present embodiment, when a position of the head of the golf club 3 at address (during standing still) is set to the origin, an XYZ coordinate system (global coordinate system) is defined which has a target line indicating a target hit ball direction as an X axis, an axis on a horizontal plane which is perpendicular to the X axis as a Y axis, and a vertically upward direction (a direction opposite to the gravitational direction) as a Z axis. In order to calculate each index value, the swing analysis portion 211 calculates a position and an attitude of the sensor unit 10 in a time series from the time of the address in the XYZ coordinate system (global coordinate system) using measured data (acceleration data and angular velocity data) in the sensor unit 10. The swing analysis portion 211 detects respective timings of the swing starting, the top, and the impact illustrated in FIG. 6, using the measured data (acceleration data or angular velocity data) in the sensor unit 10. The swing analysis portion 211 calculates values of the respective indexes (for example, a V zone, swing efficiency, rotation, impact, and a down blow (or an upper blow) illustrated in the radar chart of FIG. 9) of the swing using the time series data of the position and the attitude of the sensor unit 10, and the timings of the swing starting, the top, and the impact, so as to generate the swing analysis data 248.

### 1-3-1. Calculation of Position and Attitude of Sensor Unit 10

If the user 2 performs the action in step S4 in FIG. 4, first, the swing analysis portion 211 determines that the user 2 stands still at an address attitude in a case where an amount of changes in acceleration data measured by the acceleration sensor 12 does not continuously exceed a threshold value for a predetermined period of time. Next, the swing analysis portion 211 computes an offset amount included in the measured data using the measured data (acceleration data and angular velocity data) for the predetermined period of time. Next, the swing analysis portion 211 subtracts the offset amount from the measured data so as to perform bias correction, and computes a position and an attitude of the sensor unit 10 during a swing action of the user 2 (during the action in step S6 in FIG. 4) using the bias-corrected measured data.

Specifically, first, the swing analysis portion 211 computes a position (initial position) of the sensor unit 10 during standing still (at address) of the user 2 in the XYZ coordinate system (global coordinate system) using the acceleration data measured by the acceleration sensor 12, the golf club information 242, and the sensor attachment position information 246.

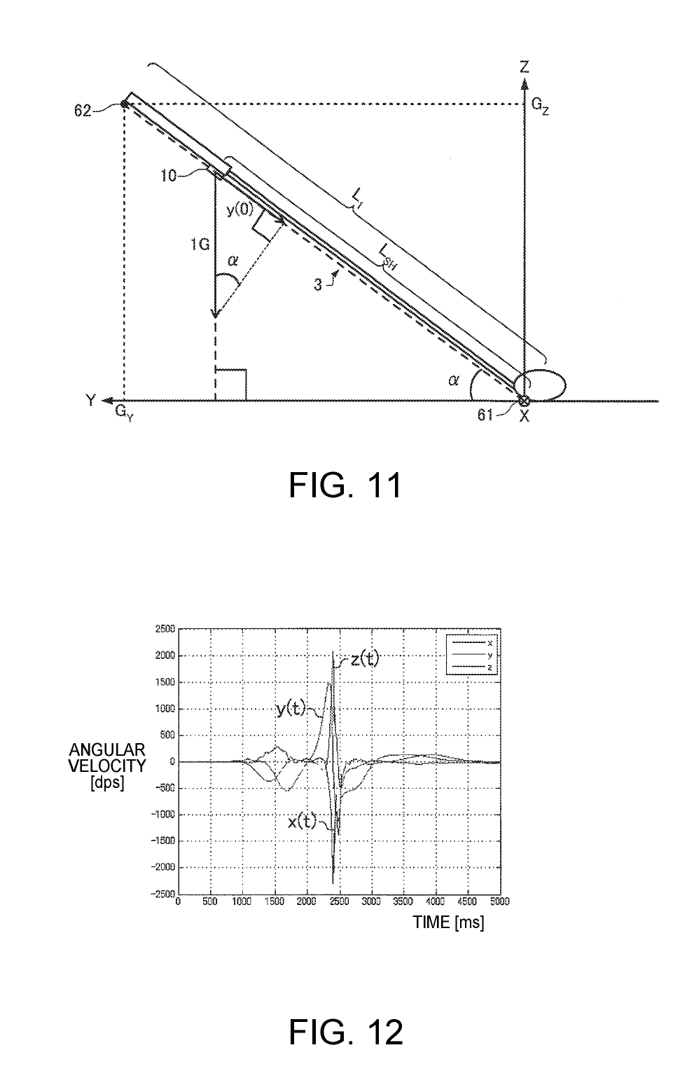

FIG. 11 is a plan view in which the golf club 3 and the sensor unit 10 during standing still (at address) of the user 2 are viewed from a negative side of the X axis. The origin O (0,0,0) is set at a position 61 of the head of the golf club 3, and coordinates of a position 62 of a grip end are (0, G_{Y}, G_{Z}). Since the user 2 performs the action in step S4 in FIG. 4, the position 62 of the grip end or the initial position of the sensor unit 10 has an X coordinate of 0, and is present on a YZ plane. As illustrated in FIG. 11, the gravitational acceleration of 1G is applied to the sensor unit 10 during standing still of the user 2, and thus a relationship between a y axis acceleration y(0) measured by the sensor unit 10 and an inclined angle (an angle formed between the long axis of the shaft and the horizontal plane (XY plane)) a of the shaft of the golf club 3 is expressed by Equation (1).

y(0)=1G·sin α (1)

Therefore, the swing analysis portion 211 can calculate the inclined angle α according to Equation (1) using any acceleration data between any time points at address (during standing still).

Next, the swing analysis portion 211 subtracts a distance L_{BG} between the sensor unit 10 and the grip end included in the sensor attachment position information 246 from a length L₁ of the shaft included in the golf club information 242, so as to obtain a distance L_{SH} between the sensor unit 10 and the head. The swing analysis portion 211 sets, as the initial position of the sensor unit 10, a position separated by the distance L_{SH} from the position 61 (origin O) of the head in a direction (a negative direction of the y axis of the sensor unit 10) specified by the inclined angle α of the shaft.

The swing analysis portion 211 integrates subsequent acceleration data so as to compute coordinates of a position from the initial position of the sensor unit 10 in a time series.

The swing analysis portion 211 computes an attitude (initial attitude) of the sensor unit 10 during standing still (at address) of the user 2 in the XYZ coordinate system (global coordinate system) using acceleration data measured by the acceleration sensor 12. Since the user 2 performs the action in step S4 in FIG. 4, the x axis of the sensor unit 10 matches the X axis of the XYZ coordinate system in terms of direction at address (during standing still) of the user 2, and the y axis of the sensor unit 10 is present on the YZ plane. Therefore, the swing analysis portion 211 can specify the initial attitude of the sensor unit 10 on the basis of the inclined angle α of the shaft of the golf club 3.

The swing analysis portion 211 computes changes in attitudes from the initial attitude of the sensor unit 10 in a time series by performing rotation calculation using angular velocity data which is subsequently measured by the angular velocity sensor 14. An attitude of the sensor unit 10 may be expressed by, for example, rotation angles (a roll angle, a pitch angle, and a yaw angle) about the X axis, the Y axis, and the Z axis, or a quaternion.

The signal processing section 16 of the sensor unit 10 may compute an offset amount of measured data so as to perform bias correction on the measured data, and the acceleration sensor 12 and the angular velocity sensor 14 may have a bias correction function. In this case, it is not necessary for the swing analysis portion 211 to perform bias correction on the measured data.

### 1-3-2. Detection of Swing Starting, Top and Impact Timings

First, the swing analysis portion 211 detects a timing (impact timing) at which the user 2 hit a ball using measured data. For example, the swing analysis portion 211 may compute a combined value of measured data (acceleration data or angular velocity data), and may detect an impact timing (time point) on the basis of the combined value.

Specifically, first, the swing analysis portion 211 computes a combined value n₀(t) of angular velocities at each time point t using the angular velocity data (bias-corrected angular velocity data for each time point t). For example, if the angular velocity data items at the time point t are respectively indicated by x(t), y(t), and z(t), the swing analysis portion 211 computes the combined value n₀(t) of the angular velocities according to the following Equation (2).

n₀(t)=\sqrt{x(t)²+y(t)²+z(t)²} (2)

Next, the swing analysis portion 211 converts the combined value n₀(t) of the angular velocities at each time point t into a combined value n(t) which is normalized (scale-conversion) within a predetermined range. For example, if the maximum value of the combined value of the angular velocities in an acquisition period of measured data is max (n₀), the swing analysis portion 211 converts the combined value n₀(t) of the angular velocities into the combined value n(t) which is normalized within a range of 0 to 100 according to the following Equation (3).

$$n ( t ) = \frac{100 \times {n}_{0} ( t )}{max ( {n}_{0} )} \qquad ( 3 )$$

Next, the swing analysis portion 211 computes a derivative dn(t) of the normalized combined value n(t) at each time point t. For example, if a cycle for measuring three-axis angular velocity data items is indicated by Δt, the swing analysis portion 211 computes the derivative (difference) dn(t) of the combined value of the angular velocities at the time point t using the following Equation (4).

dn(t)=n(t)−n(t−Δt) (4)

FIG. 12 illustrates examples of three-axis angular velocity data items x(t), y(t) and z(t) obtained when the user 2 hits the golf ball 4 by performing a swing. In FIG. 12, a transverse axis expresses time (msec), and a longitudinal axis expresses angular velocity (dps).

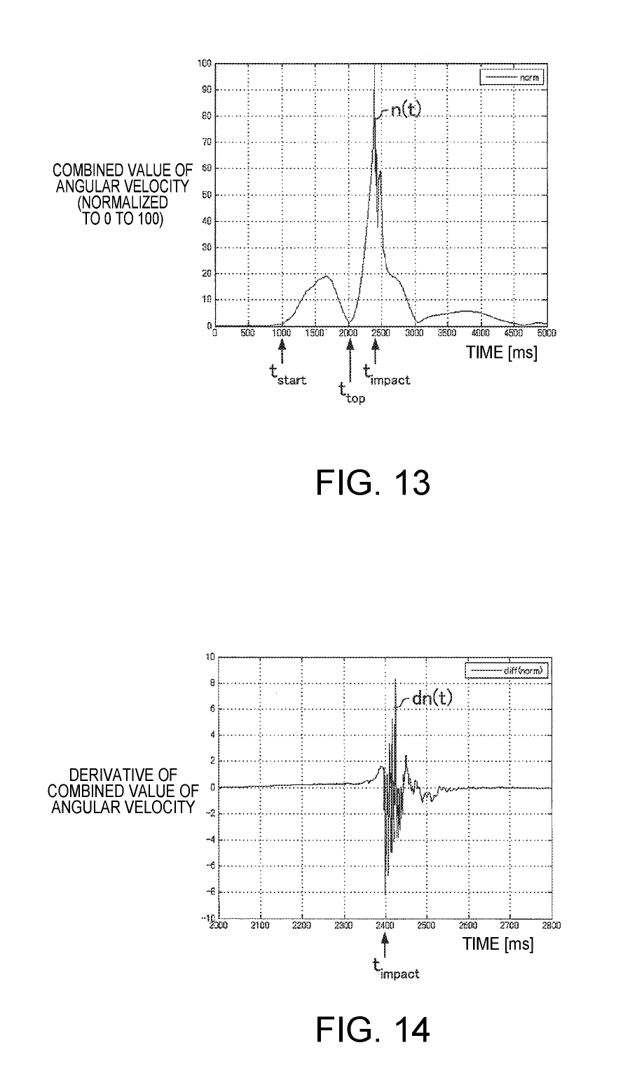

FIG. 13 is a diagram in which the combined value n₀(t) of the three-axis angular velocities is computed according to Equation (2) using the three-axis angular velocity data items x(t), y(t) and z(t) in FIG. 12, and then the combined value n(t) normalized to 0 to 100 according to Equation (3) is displayed in a graph. In FIG. 13, a transverse axis expresses time (msec), and a longitudinal axis expresses a norm of the angular velocity.

FIG. 14 is a diagram in which the derivative dn(t) is calculated according to Equation (4) on the basis of the combined value n(t) of the three-axis angular velocities in FIG. 13, and is displayed in a graph. In FIG. 14, a transverse axis expresses time (msec), and a longitudinal axis expresses a derivative value of the combined value of the three-axis angular velocities. In FIGS. 12 and 13, the transverse axis is displayed at 0 seconds to 5 seconds, but, in FIG. 14, the transverse axis is displayed at 2 seconds to 2.8 seconds so that changes in the derivative value before and after impact can be understood.

Next, of time points at which a value of the derivative dn(t) of the combined value becomes the maximum and the minimum, the swing analysis portion 211 specifies the earlier time point as an impact time point t_{impact} (impact timing) (refer to FIG. 14). It is considered that swing speed is the maximum at the moment of impact in a typical golf swing. In addition, since it is considered that a value of the combined value of the angular velocities also changes according to a swing speed, the swing analysis portion 211 can capture a timing at which a derivative value of the combined value of the angular velocities is the maximum or the minimum (that is, a timing at which the derivative value of the combined value of the angular velocities is a positive maximum value or a negative minimum value) in a series of swing actions as the impact timing. Since the golf club 3 vibrates due to the impact, a timing at which a derivative value of the combined value of the angular velocities is the maximum and a timing at which a derivative value of the combined value of the angular velocities is the minimum may occur in pairs, and, of the two timings, the earlier timing may be the moment of the impact.

Next, the swing analysis portion 211 specifies a time point of a minimum point at which the combined value n(t) is close to 0 before the impact time point t_{impact}, as a top time point tₜₒₚ (top timing) (refer to FIG. 13). It is considered that, in a typical golf swing, an action temporarily stops at the top after starting the swing, then a swing speed increases, and finally impact occurs. Therefore, the swing analysis portion 211 can capture a timing at which the combined value of the angular velocities is close to 0 and becomes the minimum before the impact timing, as the top timing.

Next, the swing analysis portion 211 sets an interval in which the combined value n(t) is equal to or smaller than a predetermined threshold value before and after the top time point tₜₒₚ, as a top interval, and detects a last time point at which the combined value n(t) is equal to or smaller than the predetermined threshold value before a starting time point of the top interval, as a swing starting (backswing starting) time point tₛₜₐᵣₜ (refer to FIG. 13). It is hardly considered that, in a typical golf swing, a swing action is started from a standing still state, and the swing action is stopped till the top. Therefore, the swing analysis portion 211 can capture the last timing at which the combined value of the angular velocities is equal to or smaller than the predetermined threshold value before the top interval as a timing of starting the swing action. The swing analysis portion 211 may detect a time point of the minimum point at which the combined value n(t) is close to 0 before the top time point tₜₒₚ as the swing starting time point tₛₜₐᵣₜ.

The swing analysis portion 211 may also detect each of a swing starting timing, a top timing, and an impact timing using three-axis acceleration data in the same manner.

### 1-3-3. Calculation of Shaft Plane and Hogan Plane

The shaft plane is a first virtual plane specified by a target line (target hit ball direction) and the longitudinal direction of the shaft of the golf club 3 at address (standing still state) of the user 2 before starting a swing. The Hogan plane is a second virtual plane specified by a virtual line connecting the vicinity of the shoulder (the shoulder or the base of the neck) of the user 2 to the head of the golf club (or the golf ball 4), and the target line (target hit ball direction), at address of the user 2.

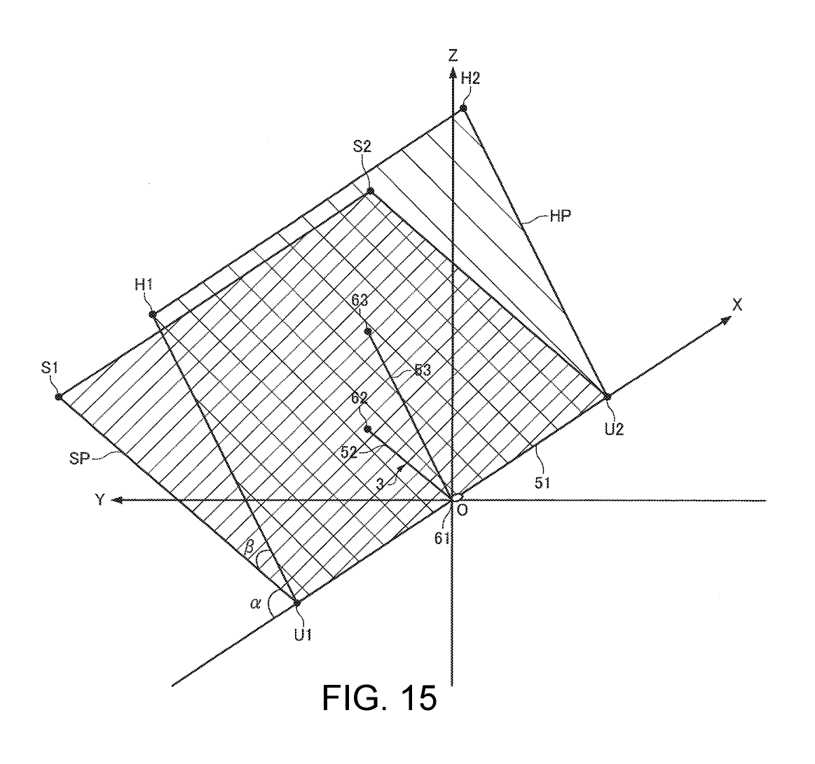

FIG. 15 is a diagram illustrating the shaft plane and the Hogan plane. FIG. 15 displays the X axis, the Y axis, and the Z axis of the XYZ coordinate system (global coordinate system).

As illustrated in FIG. 15, in the present embodiment, a virtual plane which includes a first line segment 51 as a first axis along a target hit ball direction and a second line segment 52 as a second axis along the longitudinal direction of the shaft of the golf club 3, and has four vertices such as U1, U2, S1, and S2, is set as the shaft plane SP (first virtual plane). In the present embodiment, the position 61 of the head of the golf club 3 at address is set as the origin O (0,0,0) of the XYZ coordinate system, and the second line segment 52 is a line segment connecting the position 61 (origin O) of the head of the golf club 3 to the position 62 of the grip end. The first line segment 51 is a line segment having a length UL in which U1 and U2 on the X axis are both ends, and the origin O is a midpoint. Since the user 2 performs the action in step S4 in FIG. 4 at address, and thus the shaft of the golf club 3 is perpendicular to the target line (X axis), the first line segment 51 is a line segment orthogonal to the longitudinal direction of the shaft of the golf club 3, that is, the second line segment 52. The swing analysis portion 211 calculates coordinates of the four vertices U1, U2, S1, and S2 of the shaft plane SP in the XYZ coordinate system.

Specifically, first, the swing analysis portion 211 computes coordinates (0,G_{Y},G_{Z}) of the position 62 of the grip end of the golf club 3 using the inclined angle α and the length L₁ of the shaft included in the golf club information 242. As illustrated in FIG. 11, the swing analysis portion 211 may compute G_{Y} and G_{Z} using the length L₁ of the shaft and the inclined angle α according to Equations (5) and (6).

G_{Y}=L₁·cos α (5)

G_{Z}=L₃·sin α (6)

Next, the swing analysis portion 211 multiplies the coordinates (0,G_{Y},G_{Z}) of the position 62 of the grip end of the golf club 3 by a scale factor S so as to compute coordinates (0,S_{Y},S_{Z}) of a midpoint S3 of the vertex S1 and the vertex S2 of the shaft plane SP. In other words, the swing analysis portion 211 computes S_{Y} and S_{Z} according to Equations (7) and (8), respectively.

S_{Y}=G_{Y}·S (7)

S_{Z}=G_{Z}·S (8)

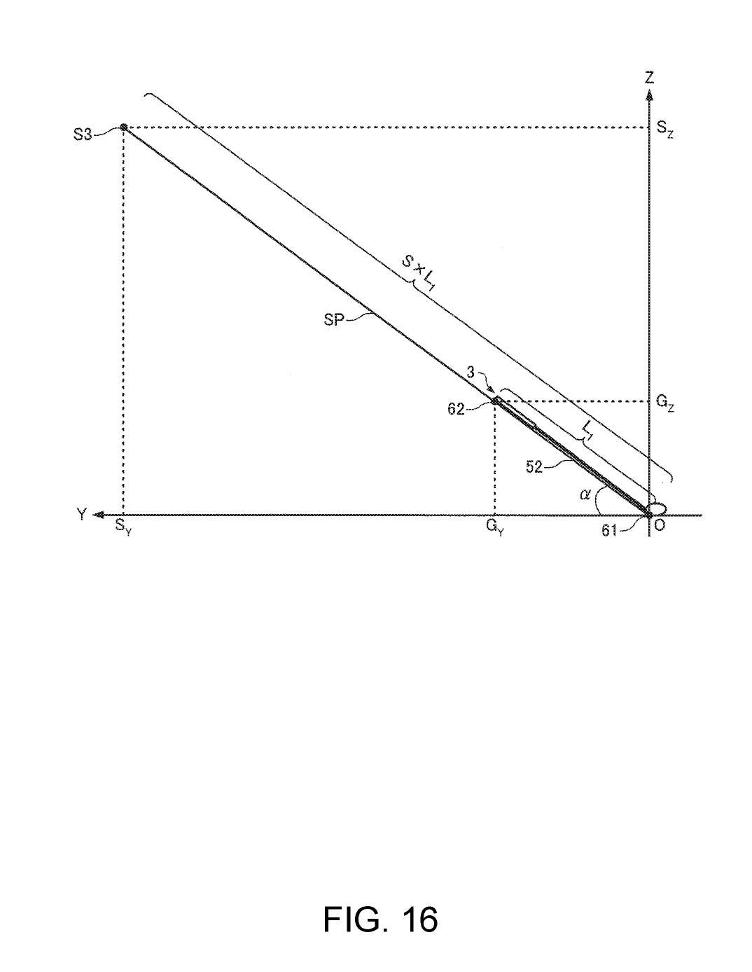

FIG. 16 is a view in which a sectional view of the shaft plane SP in FIG. 15 which is cut in the YZ plane is viewed from the negative side of the X axis. As illustrated in FIG. 16, a length (a width of the shaft plane SP in a direction orthogonal to the X axis) of a line segment connecting the midpoint S3 of the vertex S1 and the vertex S2 to the origin O is S times the length L₁ of the second line segment 52. The scale factor S is set to a value at which a trajectory of the golf club 3 during a swing action of the user 2 enters the shaft plane SP. For example, if a length of the arms of the user 2 is indicated by L₂, the scale factor S may be set as in Equation (9) so that the width S×L₁ of the shaft plane SP in the direction orthogonal to the X axis is twice the sum of the length L₁ of the shaft and the length L₂ of the arms.

$$S = \frac{2 \cdot ( {L}_{1} + {L}_{2} )}{{L}_{1}} \qquad ( 9 )$$

The length L₂ of the arms of the user 2 is associated with a height L₀ of the user 2. The length L₂ of the arms is expressed by a correlation expression such as Equation (10) in a case where the user 2 is a male, and is expressed by a correlation expression such as Equation (11) in a case where the user 2 is a female, on the basis of statistical information.

L₂=0.41×L₀−45.5 [mm] (10)

L₂=0.46×L₀−126.9 [mm] (11)

Therefore, the swing analysis portion 211 may calculate the length L₂ of the arms of the user according to Equation (10) or Equation (11) using the height L₀ and the sex of the user 2 included in the physical information 244.

Next, the swing analysis portion 211 computes coordinates (−UL/2,0,0) of the vertex U1 of the shaft plane SP, coordinates (UL/2,0,0) of a vertex U2, coordinates (−UL/2,S_{Y},S_{Z}) of the vertex S1, and coordinates (UL/2,S_{Y},S_{Z}) of the vertex S2 using the coordinates (0,S_{Y},S_{Z}) of the midpoint S3 and a width (the length of the first line segment 51) UL of the shaft plane SP in the X axis direction. The width UL in the X axis direction is set to a value at which a trajectory of the golf club 3 during a swing action of the user 2 enters the shaft plane SP. For example, the width UL in the X axis direction may be set to be same as the width S×L₁ in the direction orthogonal to the X axis, that is, twice the sum of the length L₁ of the shaft and the length L₂ of the arms.

In the above-described manner, the swing analysis portion 211 can calculate the coordinates of the four vertices U1, U2, S1, and S2 of the shaft plane SP.

As illustrated in FIG. 15, in the present embodiment, a virtual plane which includes a first line segment 51 as a first axis and a third line segment 53 as a third axis, and has four vertices such as U1, U2, H1, and H2, is used as the Hogan plane HP (second virtual plane). The third line segment 53 is a line segment connecting a predetermined position 63 in the vicinity of a line segment connecting both of the shoulders of the user 2, to the position 61 of the head of the golf club 3. However, the third line segment 53 may be a line segment connecting the predetermined position 63 to a position of the golf ball 4. The swing analysis portion 211 calculates respective coordinates of the four vertices U1, U2, H1, and H2 of the Hogan plane HP in the XYZ coordinate system.

Specifically, first, the swing analysis portion 211 estimates the predetermined position 63 using the coordinates (0,G_{Y},G_{Z}) of the position 62 of the grip end of the golf club 3 at address (during standing still), and the length L₂ of the arms of the user 2 based on the physical information 244, and computes coordinates (A_{X},A_{Y},A_{Z}) thereof.

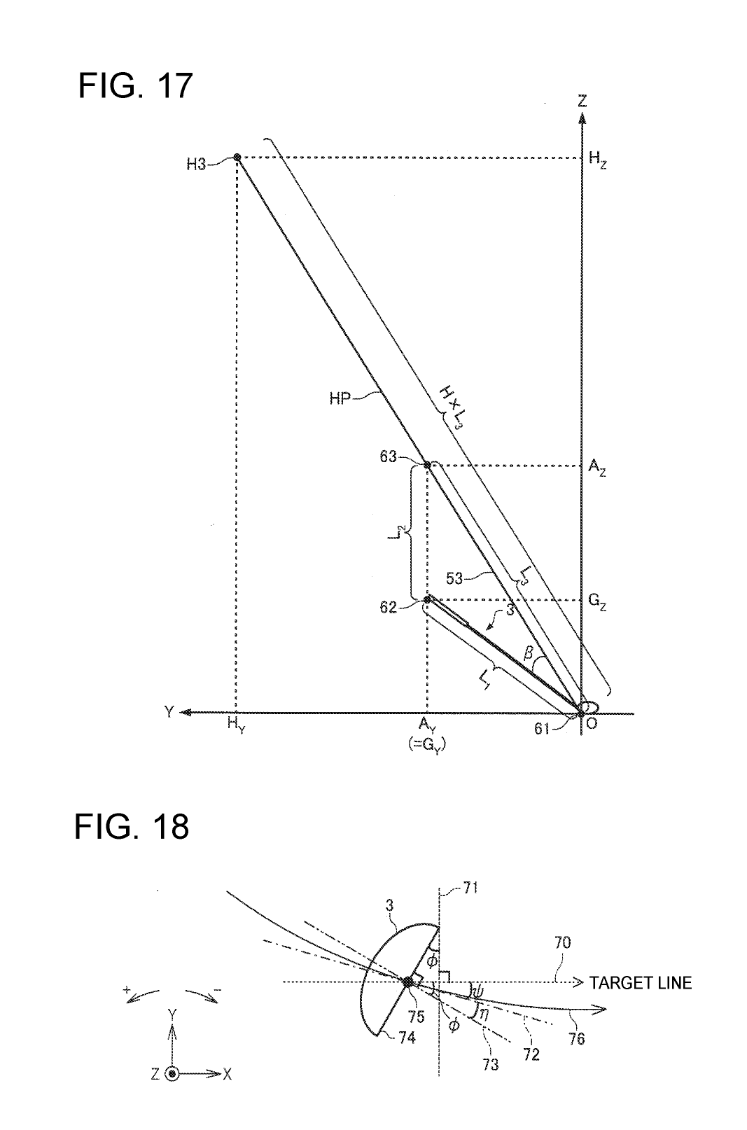

FIG. 17 is a view in which a sectional view of the Hogan plane HP illustrated in FIG. 15 which is cut in the YZ plane is viewed from the negative side of the X axis. In FIG. 17, a midpoint of the line segment connecting both of the shoulders of the user 2 is the predetermined position 63, and the predetermined position 63 is present on the YZ plane. Therefore, an X coordinate A_{X} of the predetermined position 63 is 0. As illustrated in FIG. 17, the swing analysis portion 211 estimates, as the predetermined position 63, a position obtained by moving the position 62 of the grip end of the golf club 3 by the length L₂ of the arms of the user 2 in a positive direction along the Z axis. Therefore, the swing analysis portion 211 sets a Y coordinate A of the predetermined position 63 to be the same as the Y coordinate G_{Y} of the position 62 of the grip end. The swing analysis portion 211 computes a Z coordinate A_{Z} of the predetermined position 63 as a sum of the Z coordinate G_{Z} of the position 62 of the grip end and the length L₂ of the arms of the user 2 as in Equation (12).

A_{Z}=G_{Z}+L₂ (12)

Next, the swing analysis portion 211 multiplies the Y coordinate A_{Y} and the Z coordinate A_{Z} of the predetermined position 63 by a scale factor H, so as to compute coordinates (0,H_{Y},H_{Z}) of a midpoint H3 of the vertex H1 and the vertex H2 of the Hogan plane HP. In other words, the swing analysis portion 211 computes H_{Y} and H_{Z} according to Equation (13) and Equation (14), respectively.

H_{Y}=A_{Y}·H (13)

H_{Z}=A_{Z}·H (14)

As illustrated in FIG. 17, a length (a width of the Hogan plane HP in a direction orthogonal to the X axis) of a line segment connecting the midpoint H3 of the vertex H1 and the vertex H2 to the origin O is H times the length L₃ of the third line segment 53. The scale factor H is set to a value at which a trajectory of the golf club 3 during a swing action of the user 2 enters the Hogan plane HP. For example, the Hogan plane HP may have the same shape and size as the shape and the size of the shaft plane SP. In this case, the width H×L₃ of the Hogan plane HP in the direction orthogonal to the X axis matches the width S×L₁ of the shaft plane SP in the direction orthogonal to the X axis, and is twice the sum of the length L₁ of the shaft of the golf club 3 and the length L₂ of the arms of the user 2. Therefore, the swing analysis portion 211 may compute the scale factor H according to Equation (15).

$$H = \frac{2 \cdot ( {L}_{1} + {L}_{2} )}{{L}_{3}} \qquad ( 15 )$$

The swing analysis portion 211 may compute the length L₃ of the third line segment 53 according to Equation (13) using the Y coordinate A_{Y} and the Z coordinate A_{Z} of the predetermined position 63.

Next, the swing analysis portion 211 computes coordinates (−UL/2,H_{Y},H_{Z}) of the vertex H1 of the Hogan plane HP, and coordinates (UL/2,H_{Y},H_{Z}) of the vertex H2 using the coordinates (0,H_{Y},H_{Z}) of the midpoint H3 and a width (the length of the first line segment 51) UL of the Hogan plane HP in the X axis direction. The two vertices U1 and U2 of the Hogan plane HP are the same as those of the shaft plane SP, and thus the swing analysis portion 211 does not need to compute coordinates of the vertices U1 and U2 of the Hogan plane HP again.

In the above-described manner, the swing analysis portion 211 can calculate the coordinates of the four vertices U1, U2, H1, and H2 of the Hogan plane HP.

A region interposed between the shaft plane SP (first virtual plane) and the Hogan plane HP (second virtual plane) is referred to as a “V zone”, and a trajectory of a hit ball (a ball line) may be estimated to some extent on the basis of a relationship between a position of the head of the golf club 3 and the V zone during a backswing or a downswing. For example, in a case where the head of the golf club 3 is present in a space lower than the V zone at a predetermined timing during a backswing or a downswing, a hit ball is likely to fly in a hook direction. In a case where the head of the golf club 3 is present in a space higher than the V zone at a predetermined timing during a backswing or a downswing, a hit ball is likely to fly in a slice direction. In the present embodiment, as is clear from FIG. 17, a first angle β formed between the shaft plane SP and the Hogan plane HP is determined depending on the length L₁ of the shaft of the golf club 3 and the length L₂ of the arms of the user 2. In other words, since the first angle (is not a fixed value, and is determined depending on the type of golf club 3 or physical features of the user 2, the more appropriate shaft plane SP and Hogan plane HP (V zone) are calculated as an index for diagnosing a swing of the user 2.

### 1-3-4. Calculation of Head Positions at Halfway Back and Halfway Down

A head position at halfway back is a position of the head at the moment of the halfway back, right before the halfway back, or right after the halfway back, and a head position at halfway down is a position of the head at the moment of the halfway back, right before the halfway back, or right after the halfway back.

First, the swing analysis portion 211 computes a position of the head and a position of the grip end at each time point t using the position and the attitude of the sensor unit 10 at each time point t from the swing start time point tₛₜₐᵣₜ to the impact time point t_{impact}.

Specifically, the swing analysis portion 211 uses a position separated by the distance L_{SH} in the positive direction of they axis specified by the attitude of the sensor unit 10, from the position of the sensor unit 10 at each time point t as the position of the head, and computes coordinates of the position of the head. As described above, the distance L_{SH} is a distance between the sensor unit 10 and the head. The swing analysis portion 211 uses a position separated by the distance L_{SG} in the negative direction of the y axis specified by the attitude of the sensor unit 10, from the position of the sensor unit 10 at each time point t as the position of the grip end, and computes coordinates of the position of the grip end. As described above, the distance L_{SG} is a distance between the sensor unit 10 and the grip end.

Next, the swing analysis portion 211 detects a halfway back timing and a halfway down timing using the coordinates of the position of the head and the coordinates of the position of the grip end.

Specifically, the swing analysis portion 211 computes a difference ΔZ between a Z coordinate of the position of the head and a Z coordinate of the position of the grip end at each time point t from the swing start time point tₛₜₐᵣₜ to the impact time point t_{impact}. The swing analysis portion 211 detects a time point t_{HWB} at which a sign of ΔZ is inverted between the swing start time point tₛₜₐᵣₜ and the top time point tₜₒₚ, as the halfway back timing. The swing analysis portion 211 detects a time point t, at which a sign of ΔZ is inverted between the top time point tₜₒₚ and impact time point t_{impact}, as the halfway down timing.

The swing analysis portion 211 uses the position of the head at the time point t_{HWS} as a position of the head at halfway back, and uses the position of the head at the time point t_{HWD} as a position of the head at halfway down.

### 1-3-5. Calculation of Head Speed

A head speed is the magnitude of a speed of the head at impact (the moment of the impact, right before the impact, or right after the impact). For example, the swing analysis portion 211 computes a speed of the head at the impact time point t_{impact} on the basis of differences between the coordinates of the position of the head at the impact time point t_{impact} and coordinates of a position of the head at the previous time point. The swing analysis portion 211 computes the magnitude of the speed of the head as the head speed.

### 1-3-6. Calculation of Face Angle and Club Path (Incidence Angle)

The face angle is an index based on an inclination of the head of the golf club 3 at impact, and the club path (incidence angle) is an index based on a trajectory of the head of the golf club 3 at impact.

FIG. 18 is a diagram for explaining the face angle and the club path (incidence angle). FIG. 18 illustrates the golf club 3 (only the head is illustrated) on the XY plane viewed from a positive side of the Z axis in the XYZ coordinate system. In FIG. 18, the reference numeral 74 indicates a face surface (hitting surface) of the golf club 3, and the reference numeral 75 indicates a ball hitting point. The reference numeral 70 indicates a target line indicating a target hit ball direction, and the reference numeral 71 indicates a plane orthogonal to the target line 70. The reference numeral 76 indicates a curve indicating a trajectory of the head of the golf club 3, and the reference numeral 72 is a tangential line at the ball hitting point 75 for the curve 76. In this case, the face angle φ is an angle formed between the plane 71 and the face surface 74, that is, an angle formed between a straight line 73 orthogonal to the face surface 74, and the target line 70. The club path (incidence angle) ψ is an angle formed between the tangential line 72 (a direction in which the head in the XY plane passes through the ball hitting point 75) and the target line 70.

For example, assuming that an angle formed between the face surface of the head and the x axis direction is normally constant (for example, orthogonal), the swing analysis portion 211 computes a direction of a straight line orthogonal to the face surface on the basis of the attitude of the sensor unit 10 at the impact time point t_{impact}. The swing analysis portion 211 uses, a straight line obtained by setting a Z axis component of the direction of the straight line to 0, as a direction of the straight line 73, and computes an angle (face angle) φ formed between the straight line 73 and the target line 70.

For example, the swing analysis portion 211 uses a direction of a speed (that is, a speed of the head in the XY plane) obtained by setting a Z axis component of a speed of the head at the impact time point t_{impact} to 0, as a direction of the tangential line 72, and computes an angle (club path (incidence angle)) ψ formed between the tangential line 72 and the target line 70.

The face angle φ indicates an inclination of the face surface 74 with the target line 70 whose direction is fixed regardless of an incidence direction of the head to the ball hitting point 75 as a reference, and is thus also referred to as an absolute face angle. In contrast, an angle η formed between the straight line 73 and the tangential line 72 indicates an inclination of the face surface 74 with an incidence direction of the head to the ball hitting point 75 as a reference, and is thus referred to as a relative face angle. The relative face angle η is an angle obtained by subtracting the club path (incidence angle) from the (absolute) face angle

### 1-3-7. Calculation of Shaft Axis Rotation Angle at Top

The shaft axis rotation angle θₜₒₚ at top is an angle (relative rotation angle) by which the golf club 3 is rotated about a shaft axis from a reference timing to a top timing. The reference timing is, for example, the time of starting a backswing, or the time of address. In the present embodiment, in a case where the user 2 is a right-handed golfer, a right-handed screw tightening direction toward the tip end on the head side of the golf club 3 (a clockwise direction when the head is viewed from the grip end side) is a positive direction of the shaft axis rotation angle θₜₒₚ. Conversely, in a case where the user 2 is a left-handed golfer, a left-handed screw tightening direction toward the tip end on the head side of the golf club 3 (a counterclockwise direction when the head is viewed from the grip end side) is a positive direction of the shaft axis rotation angle θₜₒₚ.

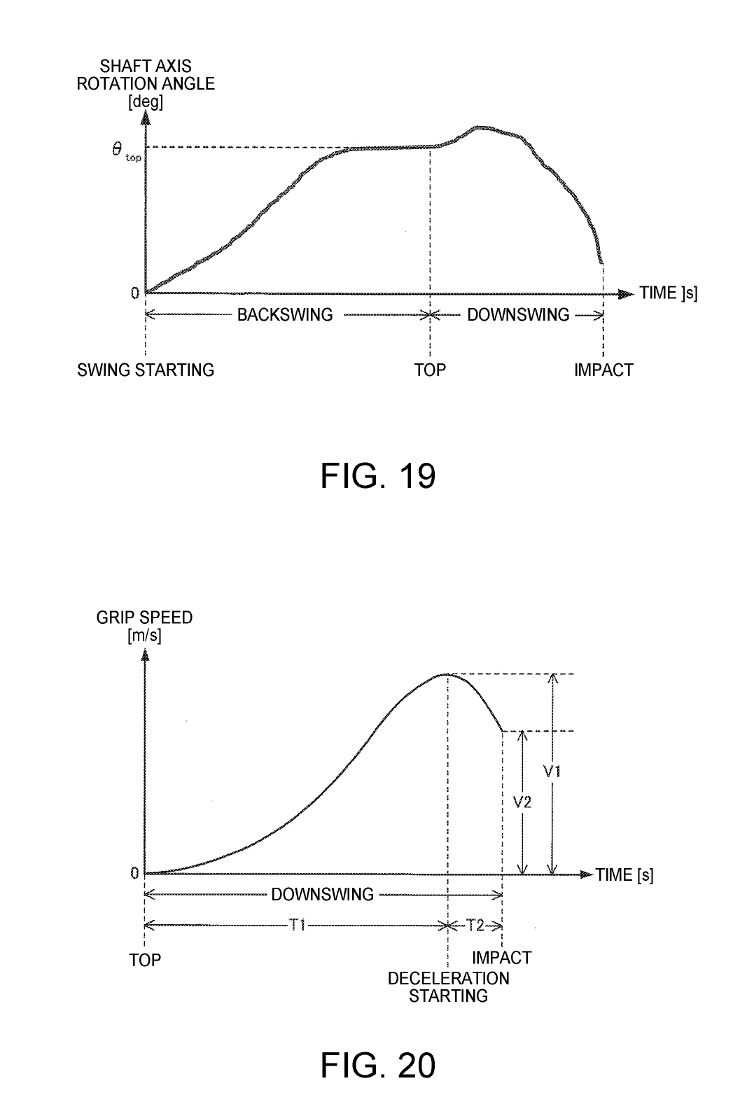

FIG. 19 is a diagram illustrating an example of a temporal change of the shaft axis rotation angle from starting of a swing (starting of a backswing) to impact. In FIG. 19, a transverse axis expresses time (s), and a longitudinal axis expresses a shaft axis rotation angle (deg). FIG. 19 illustrates the shaft axis rotation angle θₜ at top with the time of starting a swing (the time of starting a backswing) as a reference timing (at which the shaft axis rotation angle is 0°).

In the present embodiment, as illustrated in FIG. 3, the y axis of the sensor unit 10 substantially matches the longitudinal direction of the shaft of the golf club 3 (the longitudinal direction of the golf club 3). Therefore, for example, the swing analysis portion 211 time-integrates a y axis angular velocity included in angular velocity data from the swing starting (backswing starting) time point tₛₜₐᵣₜ or the time of address to the top time point tₜₒₚ (at top), so as to compute the shaft axis rotation angle θₜₒₚ.

### 1-3-8. Calculation of Grip Deceleration Ratio and Grip Deceleration Time Ratio

The grip deceleration ratio is an index based on a grip deceleration amount, and is a ratio between a speed of the grip when the grip starts to be decelerated during the downswing, and a speed of the grip at impact. The grip deceleration time ratio is an index based on a grip deceleration period, and is a ratio between a period of time from the time at which the grip starts to be decelerated during the downswing to the time of impact, and a period of time of the downswing. A speed of the grip is preferably a speed of a portion held by the user 2, but may be a speed of any portion of the grip (for example, the grip end), and may be a speed of a peripheral portion of the grip.

FIG. 20 is a diagram illustrating an example of a temporal change of a speed of the grip during the downswing. In FIG. 20, a transverse axis expresses time (s), and a longitudinal axis expresses a speed (m/s) of the grip. In FIG. 20, if a speed (the maximum speed of the grip) when the grip starts to be decelerated is indicated by V1, and a speed of the grip at impact is indicated by V2, a grip deceleration ratio R_{V} (unit: %) is expressed by the following Equation (16).

$${R}_{V} = \frac{V 1 - V 2}{V 1} \times 100 ( \% ) \qquad ( 16 )$$

In FIG. 20, if a period of time from the time of top to the time at which the grip starts to be decelerated is indicated by T1, and a period of time from the time at which the grip starts to be decelerated during the downswing to the time of impact is indicated by T2, a grip deceleration time ratio R_{T} (unit: %) is expressed by the following Equation (17).

$${R}_{T} = \frac{T 2}{T 1 + T 2} \times 100 ( \% ) \qquad ( 17 )$$

For example, the sensor unit 10 may be attached to the vicinity of a portion of the golf club 3 held by the user 2, and a speed of the sensor unit 10 may be regarded as a speed of the grip. Therefore, first, the swing analysis portion 211 computes a speed of the sensor unit 10 at the time point t on the basis of differences between coordinates of a position of the sensor unit 10 at each time point t from the top time point tₜₒₚ to the impact time point t_{impact} (during the downswing) and coordinates of a position of the sensor unit 10 at the previous time point.

Next, the swing analysis portion 211 computes the magnitude of the speed of the sensor unit 10 at each time point t, sets the maximum value thereof as V1, and sets the magnitude of the speed at the impact time point t_{impact} as V2. The swing analysis portion 211 specifies a time point tᵥₘₐₓ at which the magnitude of the speed of the sensor unit 10 becomes the maximum value V1. The swing analysis portion 211 computes T1=tᵥₘₐₓ−tₜₒₚ, and T2=t_{impact}−tᵥₘₐₓ. The swing analysis portion 211 computes the grip deceleration ratio R_{V} and the grip deceleration time ratio R_{T} according to Equations (16) and (17), respectively.

The swing analysis portion 211 may regard a speed of the grip end as a speed of the grip, and may compute the speed of the grip end on the basis of coordinates of a position of the grip end at each time point t during the downswing, so as to obtain the grip deceleration ratio R_{V} and the grip deceleration time ratio R_{T} through the above-described computation.

### 1-3-9. Calculation of Attack Angle and Definition of Signs of Attack Angle and Face Angle

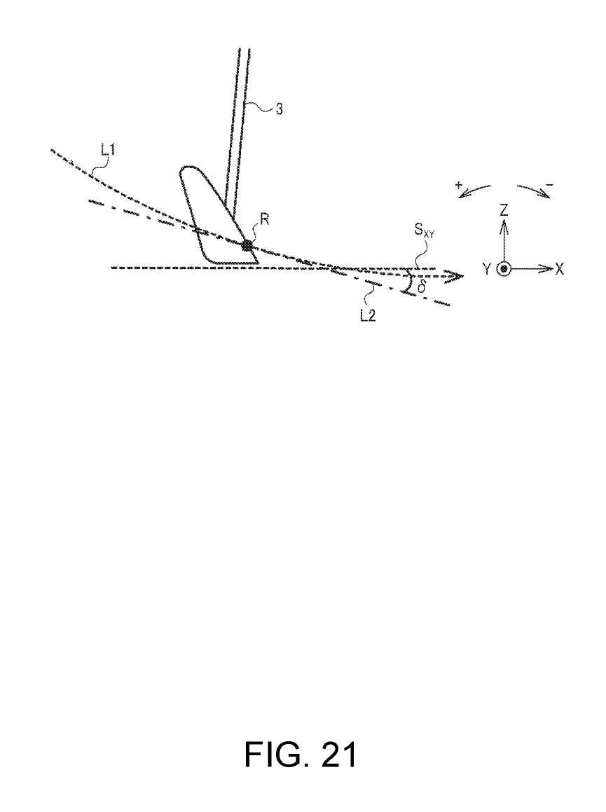

FIG. 21 is a diagram for explaining definition of an attack angle (first angle) 8. In the present embodiment, the XYZ coordinate system is defined which has a target line indicating a target hitting direction as an X axis, an axis on a horizontal plane which is perpendicular to the X axis as a Y axis, and a vertical direction (a direction opposite to the gravitational direction) as a Z axis, and FIG. 21 illustrates the X axis, the Y axis, and the Z axis. The target line indicates, for example, a target direction in which a ball flies straight. In FIG. 21, a point R is a ball hitting point at which the head of the golf club 3 comes into contact with a golf ball, a curve L1 indicates a part of a trajectory during a swing of the head of the golf club 3 in an XZ plane, and a straight line L2 is a tangential line of the curve L1 at the ball hitting point R in the XZ plane. As illustrated in FIG. 21, an attack angle is defined as an angle δ of the straight line L2 with respect to the XY plane (horizontal plane) S. In FIG. 21, a rightward direction toward the drawing surface along the X axis which is parallel to the XY plane (horizontal plane) S_{XY} is a target hitting direction. Therefore, the attack angle δ can be said to be an angle formed between a direction of the tangential line L2 which is in contact with the trajectory (swing trajectory) L1 of a swing of the head (ball hitting portion) 3b of the golf club (exercise equipment) 3 and a target hitting direction along the X axis.

The target hitting direction also includes a direction orthogonal to the face surface of the head of the golf club 3, a hitting direction which is set in advance by the user, a direction connecting a direct distance to a hole cup, and the like.

In the present embodiment, regarding signs of the attack angle (first angle) δ, when the Y axis is a rotation axis, a direction (a clockwise direction in FIG. 21) in which +Z (vertically upward direction) of the Z axis rotates in the +X direction (rightward direction toward the drawing surface) of the X axis is defined as a first sign, and a sign reverse to the first sign is defined as a second sign. As illustrated in FIG. 21, the first sign is, for example, negative (−), and the second sign is positive (+). A sign of the attack angle (first angle) δ illustrated in FIG. 21 is the first sign (negative). In other words, the attack angle δ<0° occurs at the time of a down blow in which the head is incident to the ball hitting point R obliquely downwardly toward the drawing surface. The attack angle δ=0° occurs at the time of a level blow in which the head is incident to the ball hitting point R horizontally along the X axis. The attack angle δ>0° occurs at the time of an upper blow in which the head is incident to the ball hitting point R obliquely upwardly toward the drawing surface.

On the other hand, regarding signs of the face angle (second angle) φ illustrated in FIG. 18, when the Z axis is a rotation axis, a direction (a clockwise direction toward the drawing surface in FIG. 18) in which +Y of the Y axis rotates in the +X direction of the X axis is defined as a third sign, and a sign reverse to the third sign is defined as a fourth sign. As illustrated in FIG. 18, the third sign is, for example, negative (−), and the fourth sign is positive (+). A sign of the face angle (second angle) φ illustrated in FIG. 18 is the third sign (negative). In other words, the face angle φ<0° occurs when the head reaches impact in a closed state with an inside-out trajectory. The face angle φ=0° occurs when the face surface 3b1 of the head 3b is vertically incident to the target line. The face angle φ>0° occurs when the head reaches impact in an open state with an outside-in trajectory.

The swing analysis portion 211 illustrated in FIG. 10 may include a first angle calculator which calculates the attack angle (first angle) δ and a second angle calculator which calculates the face angle (second angle) φ. The first and second angle calculators respectively calculate the first and second angles δ and φ on the basis of the relationships illustrated in FIGS. 21 and 18 using an output from the data acquisition portion 210 illustrated in FIG. 10, that is, an output from the sensor unit 10.

### 1-3-10. Procedures of Swing Analysis Process (Swing Analysis Method)

FIG. 22 is a flowchart illustrating examples of procedures of a swing analysis process (swing analysis method) performed by the processing section 21. The processing section 21 performs the swing analysis process, for example, according to the procedures shown in the flowchart of FIG. 22 by executing the swing analysis program 240 stored in the storage section 24. Hereinafter, the flowchart of FIG. 22 will be described.

First, the processing section 21 waits for the user 2 to perform a measurement starting operation (the operation in step S2 in FIG. 4) (N in step S10), transmits a measurement starting command to the sensor unit 10 if the measurement starting operation is performed (Y in step S10), and starts to acquire measured data from the sensor unit 10 (step S12).

Next, the processing section 21 instructs the user 2 to take an address attitude (step S14). The user 2 takes the address attitude in response to the instruction, and stands still (step S4 in FIG. 4).

Next, if a standing still state of the user 2 is detected using the measured data acquired from the sensor unit 10 (Y in step S16), the processing section 21 notifies the user 2 of permission of swing starting (step S18). The processing section 21 outputs, for example, a predetermined sound, or an LED is provided in the sensor unit 10, and the LED is lighted, so that the user 2 is notified of permission of swing starting. The user 2 confirms the notification and then starts a swing action (the action in step S6 in FIG. 4).

Next, the processing section 21 performs processes in step S20 and subsequent steps after completion of the swing action of the user 2, or from before completion of the swing action.

First, the processing section 21 computes an initial position and an initial attitude of the sensor unit 10 using the measured data (measured data during standing still (at address) of the user 2) acquired from the sensor unit 10 (step S20).

Next, the processing section 21 detects a swing starting timing, a top timing, and an impact timing using the measured data acquired from the sensor unit 10 (step S22).

The processing section 21 computes a position and an attitude of the sensor unit 10 during the swing action of the user 2 in parallel to the process in step S22, or before and after the process in step S22 (step S24).

Next, in steps S26 to S34, the processing section 21 computes values of various indexes regarding the swing using at least some of the measured data acquired from the sensor unit 10, the swing starting, top and impact timings detected in step S22, and the position and the attitude of the sensor unit 10 computed in step S24.

The processing section 21 computes the shaft plane SP and the Hogan plane HP in step S26.

The processing section 21 computes a head position at halfway back and a head position at halfway down in step S28.

The processing section 21 computes a head speed, the face angle φ, the attack angle δ, and the club path (incidence angle) ψ in step S30.

The processing section 21 computes the shaft axis rotation angle θₜ, at top in step S32.

The processing section 21 computes the grip deceleration ratio R_{V} and the grip deceleration time ratio R_{T} in step S34.

The processing section 21 generates the swing analysis data 248 using the various indexes calculated in steps S26 to S34, transmits the swing analysis data to the swing diagnosis apparatus 30 (step S36), and finishes the swing analysis process.

In the flowchart of FIG. 22, order of the respective steps may be changed as appropriate within an allowable range, some of the steps may be omitted or changed, and other steps may be added thereto.

### 1-4. Configuration of Swing Diagnosis Apparatus

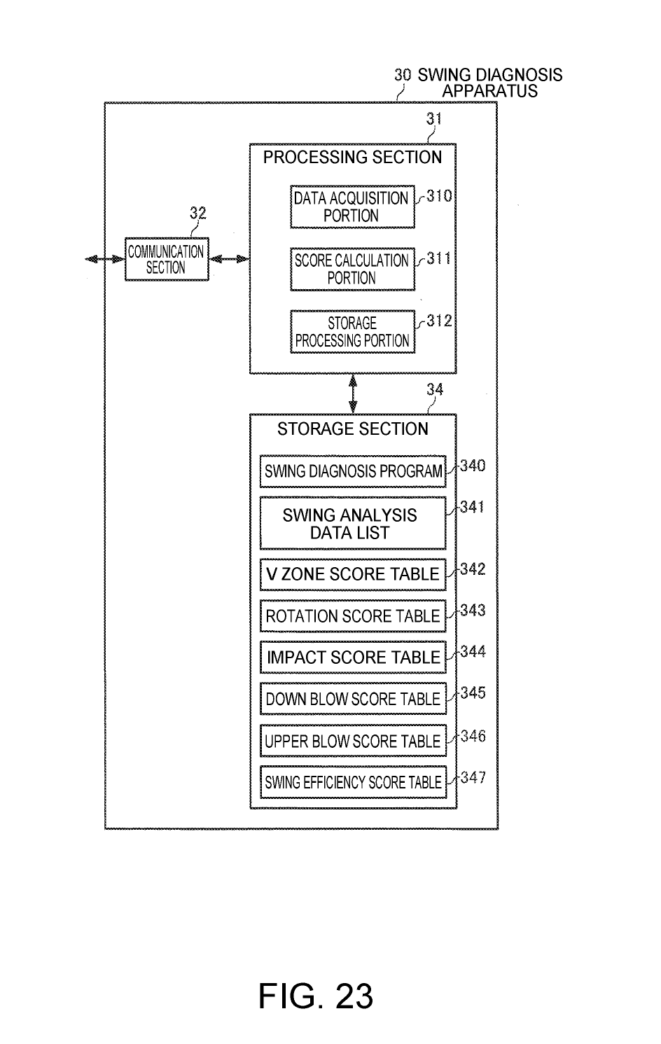

FIG. 23 is a diagram illustrating a configuration example of the swing diagnosis apparatus 30. As illustrated in FIG. 23, in the present embodiment, the swing diagnosis apparatus 30 is configured to include a processing section 31, a communication section 32, and a storage section 34. However, the swing diagnosis apparatus 30 may have a configuration in which some of the constituent elements are deleted or changed as appropriate, or may have a configuration in which other constituent elements are added thereto.

The storage section 34 is constituted of, for example, various IC memories such as a ROM, a flash ROM, and a RAM, or a recording medium such as a hard disk or a memory card. The storage section 34 stores a program for the processing section 31 performing various calculation processes or a control process, or various programs or data for realizing application functions.

In the present embodiment, the storage section 34 stores a swing diagnosis program 340 which is read by the processing section 31 and executes a swing diagnosis process. The swing diagnosis program 340 may be stored in a nonvolatile recording medium (computer readable recording medium) in advance, or the swing diagnosis program 340 may be received from a server (not illustrated) by the processing section 31 via a network, and may be stored in the storage section 34.

In the present embodiment, the storage section 34 stores (preserves) a swing analysis data list 341 including a plurality of items of swing analysis data 248 generated by the swing analysis apparatus 20. In other words, the swing analysis data 248 generated whenever the processing section 21 of the swing analysis apparatus 20 analyzes a swing action of the user 2 is sequentially added to the swing analysis data list 341.

In the present embodiment, the storage section 34 stores a V zone score table 342, a rotation score table 343, an impact score table 344, a down blow score table 345, an upper blow score table 346, and a swing efficiency score table 347. The score tables will be described later in detail.

The storage section 34 is used as a work area of the processing section 31, and temporarily stores results of calculation executed by the processing section 31 according to various programs, and the like. The storage section 34 may store data which is required to be preserved for a long period of time among data items generated through processing of the processing section 31.

The communication section 32 performs data communication with the communication section 27 (refer to FIG. 10) of the swing analysis apparatus 20 via the network 40. For example, the communication section 32 performs a process of receiving the swing analysis data 248 from the communication section 27 of the swing analysis apparatus 20, and transmitting the swing analysis data 248 to the processing section 31. For example, the communication section 32 performs a process of transmitting information required to display the selection screen illustrated in FIG. 7 to the communication section 27 of the swing analysis apparatus 20, or a process of receiving selected information on the selection screen illustrated in FIG. 7 from the communication section 27 of the swing analysis apparatus 20 and transmitting the selected information to the processing section 31. For example, the communication section 32 performs a process of receiving information required to display the input data editing screen illustrated in FIG. 8 from the processing section 31, and transmitting the information to the communication section 27 of the swing analysis apparatus 20. For example, the communication section 32 performs a process of receiving input data at the time of the diagnosis starting button on the input data editing screen illustrated in FIG. 8 being pressed from the communication section 27 of the swing analysis apparatus 20, transmitting the input data to the processing section 31, receiving diagnosis result information (scores or a total score of a plurality of items indicating features of a swing of the user 2) based on the input data from the processing section 31, and transmitting the diagnosis results information to the communication section 27 of the swing analysis apparatus 20. For example, the communication section 32 performs a process of receiving information required to display the swing diagnosis screen illustrated in FIG. 9 from the processing section 31, and transmitting the information to the communication section 27 of the swing analysis apparatus 20.

The processing section 31 performs a process of receiving the swing analysis data 248 from the swing analysis apparatus 20 via the communication section 32 and storing the swing analysis data 248 in the storage section 34 (adding the swing analysis data to the swing analysis data list 341), according to various programs. The processing section 31 performs a process of receiving various pieces of information from the swing analysis apparatus 20 via the communication section 32, and transmitting information required to display various screens (the respective screens illustrated in FIGS. 7, 8 and 9) to the swing analysis apparatus 20, according to various programs. The processing section 31 performs other various control processes.

Particularly, in the present embodiment, the processing section 31 functions as a data acquisition portion 310, a score calculation portion 311, and a storage processing portion 312 by executing the swing diagnosis program 340, and performs a diagnosis process (swing diagnosis process) on the swing analysis data 248 selected from the swing analysis data list 341.

The data acquisition portion 310 performs a process of receiving the swing analysis data 248 received from the swing analysis apparatus 20 by the communication section 32 and transmitting the swing analysis data 248 to the storage processing portion 312. The data acquisition portion 310 performs a process of receiving various pieces of information received from the swing analysis apparatus 20 by the communication section 32 and transmitting the information to the score calculation portion 311.

The storage processing portion 312 performs read/write processes of various programs or various data for the storage section 34. For example, the storage processing portion 312 performs a process of receiving the swing analysis data 248 from the data acquisition portion 310 and storing the swing analysis data 248 in the storage section 34 (adding the swing analysis data to the swing analysis data list 341), a process of reading the swing analysis data 248 from the swing analysis data list 341 stored in the storage section 34, or the like. For example, the storage processing portion 312 performs a process of reading the V zone score table 342, the rotation score table 343, the impact score table 344, the down blow score table 345, the upper blow score table 346, and the swing efficiency score table 347 stored in the storage section 34.

The score calculation portion 311 (level calculation unit) performs a process of calculating scores (levels) of a plurality of items on the basis of data regarding a swing. In the present embodiment, the data regarding a swing may be input data at the time of the diagnosis starting button on the input data editing screen illustrated in FIG. 8 being pressed, may be the swing analysis data 248 selected on the selection screen illustrated in FIG. 7, and may include both of the data.

For example, in a case where the sex, the type of golf club, and each index of a swing are not edited in a state of being initial values, and the diagnosis starting button is pressed on the input data editing screen illustrated in FIG. 8, the score calculation portion 311 performs a process of calculating scores on the basis of the swing analysis data 248 selected from the swing analysis data list 341. On the other hand, in a case where at least one of the sex, the type of golf club, and each index of a swing is edited, and then the diagnosis starting button is pressed on the input data editing screen illustrated in FIG. 8, the score calculation portion 311 performs a process of calculating scores on the basis of data (pseudo-data) in which at least a part of the selected swing analysis data 248 is edited.

A plurality of items which are score calculation targets include a first item regarding at least one of a backswing and a downswing. The first item may include an item indicating a relationship among at least one virtual plane, a position of the head (an example of a ball hitting portion) of the golf club 3 (an example of an exercise equipment) at a first timing during the backswing, and a position of the head at a second timing during the downswing. For example, the first timing may be the time at which the longitudinal direction of the golf club 3 becomes a direction along the horizontal direction during the backswing. For example, the second timing may be the time at which the longitudinal direction of the golf club 3 becomes a direction along the horizontal direction during the downswing.

At least one virtual plane may include the shaft plane SP which is a first virtual plane specified on the basis of the first line segment 51 which is a first axis along a target hit ball direction (target line) in the XY plane as a reference plane, and the second line segment 52 which is a second axis along the longitudinal direction of the golf club 3 before starting a backswing. The time before starting a backswing may be the time of address (when the user 2 takes an address attitude and stands still).

At least one virtual plane may include the Hogan plane HP which is a second virtual plane (that is, the second virtual plane which forms a first angle R with the first virtual plane) specified on the basis of the first line segment 51 which is a first axis along a target hit ball direction (target line) in the XY plane as a reference plane, and the third line segment 53 which is a third axis forming the first angle φ with the longitudinal direction of the golf club 3 before starting a backswing.

At least one virtual plane may include only one of the shaft plane SP and the Hogan plane HP. At least one virtual plane may include other virtual planes (for example, a plane interposed between the shaft plane SP and the Hogan plane HP, a plane outside the shaft plane SP and the Hogan plane HP, and a plane intersecting at least one of the shaft plane SP and the Hogan plane HP) instead of the shaft plane SP or the Hogan plane HP.

Hereinafter, the first item is assumed to include an item (hereinafter, this item will be referred to as a “V zone” item) indicating a relationship among four indexes of a swing, that is, the “shaft plane SP”, the “Hogan plane HP”, a “position of the head at halfway back”, and a “position of the head at halfway down”.

The first item may include an item regarding swing efficiency. The item regarding swing efficiency may be an item indicating a relationship between a deceleration amount and a deceleration period of the grip (an example of a holding portion) of the golf club 3 in a downswing. Hereinafter, the first item is assumed to include an item (hereinafter, this item will be referred to as a “swing efficiency” item) indicating a relationship between a “grip deceleration ratio” which is an index based on the deceleration amount of the grip and a “grip deceleration time ratio” which is an index based on the deceleration period of the grip, as the item regarding swing efficiency.

The plurality of items which are score calculation targets also include a second item regarding impact (at ball hitting). The second item may include an item indicating a relationship between an incidence angle of the head of the golf club 3 and an inclination of the head at impact (at ball hitting). Hereinafter, the second item is assumed to include an item (hereinafter, this item will be referred to as an “impact” item) indicating a relationship between the “club path (incidence angle) y” which is an index based on the incidence angle of the head of the golf club 3 at impact and the “relative face angle r” which is an index based on the inclination of the head at impact.

The second item may include an item indicating a relationship between an attack angle of the head of the golf club 3 and an absolute face angle at impact (at ball hitting). Hereinafter, the second item is assumed to include an item (hereinafter, this item will be referred to as a “down blow” item or an “upper blow” item) indicating a relationship between the “attack angle δ” which depends on a position of the head of the golf club 3 and the lowest point thereof at impact and the “absolute face angle φ” which is an index based on the inclination of the head at impact.

The plurality of items which are score calculation targets may also include a third item regarding the time at which a swing transitions from a backswing to a downswing, and the time of impact (the time of ball hitting). The third item may include an item indicating a relationship between a rotation angle about the long axis of the golf club 3 at the time (at top) at which a swing transitions from a backswing to a downswing and an inclination of the head of the golf club 3 at impact (at ball hitting). Hereinafter, the third item is assumed to include an item (hereinafter, this item will be referred to as a “rotation” item) indicating a relationship between the “shaft axis rotation angle θₜₒₚ at top” which is an index based on the rotation angle about the long axis of the golf club 3 at the top timing, and the “(absolute) face angle φ” which is an index based on the inclination of the head at impact.

The score calculation portion 311 performs a process of calculating a total score on the basis of the scores of the plurality of items. The processing section 31 transmits information regarding the scores or the total score of the plurality of items, calculated by the score calculation portion 311, to the swing analysis apparatus 20 via the communication section 32. In other words, the processing section 31 also functions as an output section which outputs the information regarding the scores (levels) or the total score of the plurality of items.

### 1-5. Swing Diagnosis Process

In the present embodiment, the processing section 31 of the swing diagnosis apparatus 30 performs a process of calculating scores and a total score of a plurality of items indicating features of a swing as a swing analysis process.

A detailed description will be made of a method of calculating a score of each item and a method of calculating a total score in the score calculation portion 311 of the processing section 31.

### 1-5-1. Calculation of Score of “V Zone” Item

The score calculation portion 311 calculates a score of the “V zone” item depending on in which regions head positions at halfway back and halfway down are included among a plurality of regions determined based on the shaft plane SP and the Hogan plane HP (V zone).

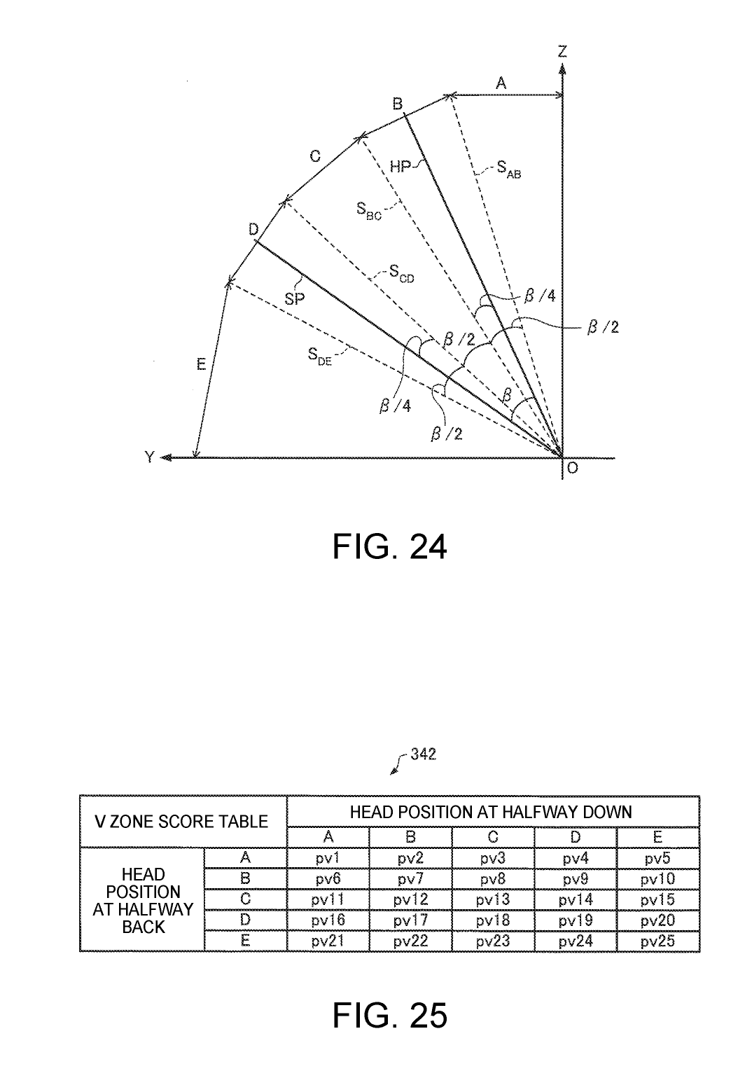

FIG. 24 is a diagram illustrating examples of relationships among the shaft plane SP and the Hogan plane HP (V zone), and a plurality of regions. FIG. 24 illustrates relationships among the shaft plane SP, the Hogan plane HP, and five regions A to E when viewed from a negative side of the X axis (when projected onto the YZ plane). The region B is a predetermined space including the Hogan plane HP, and the region D is a predetermined space including the shaft plane SP. The region C is a space interposed between the region B and the region D (a space between an interface S_{BC} with region B and an interface S_{CD} with the region D). The region A is a space in contact with the region B in an interface S_{AB} on an opposite side to the region C. The region E is a space in contact with the region D in an interface S_{DE} on an opposite side to the region C.

There may be various methods of setting the interface S_{AB}, the interface S_{BC}, the interface S_{CD}, and the interface S_{DE}. As an example, the interfaces may be set so that, on the YZ plane, the Hogan plane HP is located exactly at the center of the interface S_{AB} and the interface S_{BC}, the shaft plane SP is located exactly at the center of the interface S_{CD} and the interface S_{DE}, and angles of the region B, the region C, and the region D about the origin O (X axis) are the same as each other. In other words, with respect to the first angle β formed between the shaft plane SP and the Hogan plane HP, if each of angles formed between the Hogan plane HP, and the interface S_{AB} and the interface S_{BC} is set to β/4, and each of angles formed between the shaft plane SP, and the interface S_{CD} and the interface S_{DF} is set to β/4, angles of the region B, the region C, and the region D are all set to β/2.

Since a swing that causes a Y coordinate of a head position at halfway back or halfway down to be negative cannot be expected, an interface of the region A opposite to the interface S_{AB} is set in the XZ plane in FIG. 24. Similarly, a swing that causes a Z coordinate of a head position at halfway back or halfway down to be negative cannot be expected, and an interface of the region E opposite to the interface S_{DE} is set in the XY plane. Of course, an interface of the region A or the region E may be set so that an angle of the region A or the region E about the origin O (X axis) is the same as angles of the region B, the region C, and the region D.

Specifically, first, the score calculation portion 311 sets the interface S_{AD}, the interface S_{BC}, the interface S_{CD}, and the interface S_{DE} of the regions A to E on the basis of coordinates of each of the four vertices U1, U2, S1, and S2 of the shaft plane SP and coordinates of each of the four vertices U1, U2, H1, and H2 of the Hogan plane HP, included in data (selected swing analysis data 248) regarding a swing. Next, the score calculation portion 311 determines in which region of the regions A to E coordinates of a head position at halfway back and coordinates of a head position at halfway down included in the data (selected swing analysis data 248) regarding the swing are included. Information regarding a determination result thereof is transmitted to the swing analysis apparatus 20, and is used as the information regarding the “sex” and the “region in which a head position at halfway down is included” in the input data editing screen illustrated in FIG. 8. Thereafter, the score calculation portion 311 calculates a score corresponding to the determination result by referring to the V zone score table 342 and using information regarding a “region in which a head position at halfway back is included” and a “region in which a head position at halfway down is included”, included in the data (diagnosis target input data) regarding the swing.

In the present embodiment, as illustrated in FIG. 25, the V zone score table 342 defines a score for each combination of the region in which a head position at halfway back is included and the region in which a head position at halfway down is included. For example, in a case where a head position at halfway back is included in the region A, and a head position at halfway down is included in the region A, a score is pv1. Each of scores pv1 to pv25 illustrated in FIG. 25 is any one of, for example, 1 point to 5 points.

The score calculation portion 311 may calculate a lower score as a hit ball predicted on the basis of a relationship among the shaft plane SP, the Hogan plane HP, the head position at halfway back, and the head position at halfway down becomes more easily curved. The term “easily curved” may indicate that a trajectory after ball hitting is easily curved (easily sliced or hooked), and may indicate that a hit ball direction is easily deviated relative to a target direction (target line). Alternatively, the score calculation portion 311 may calculate a higher score as a hit ball more easily flies straight. The term “easily flies straight” may indicate that a trajectory after ball hitting is hardly curved (easily straightened), and may indicate that a hit ball direction is hardly deviated relative to a target direction (target line).

For example, in a case where a head position at halfway back is included in the region E, and a head position at halfway down is included in the region A, it is expected that a hit ball is easily curved, and thus the score calculation portion 311 calculates a relatively low score. Therefore, in the example illustrated in FIG. 25, pv21 may be 1 point which is the lowest score, for example, among 1 point to 5 points.

For example, in a case where a head position at halfway back and a head position at halfway down are all included in the region C, it is expected that a hit ball easily flies straight, and thus the score calculation portion 311 calculates a relatively high score (for example, 5 points maximum). Therefore, in the example illustrated in FIG. 25, pv13 may be 5 points which is the highest score, for example, among 1 point to 5 points.

### 1-5-2. Calculation of Score of “Rotation” Item

The score calculation portion 311 calculates a score of the “rotation” item depending on in which range among a plurality of ranges each of the shaft axis rotation angle θₜ at top and the face angle φ is included. Specifically, first, the score calculation portion 311 determines whether or not in which range each of the shaft axis rotation angle θₜₒₚ at top and the face angle φ included in data (target diagnosis input data) regarding a swing is included. Next, the score calculation portion 311 calculates a score corresponding to a determination result by referring to the rotation score table 343.

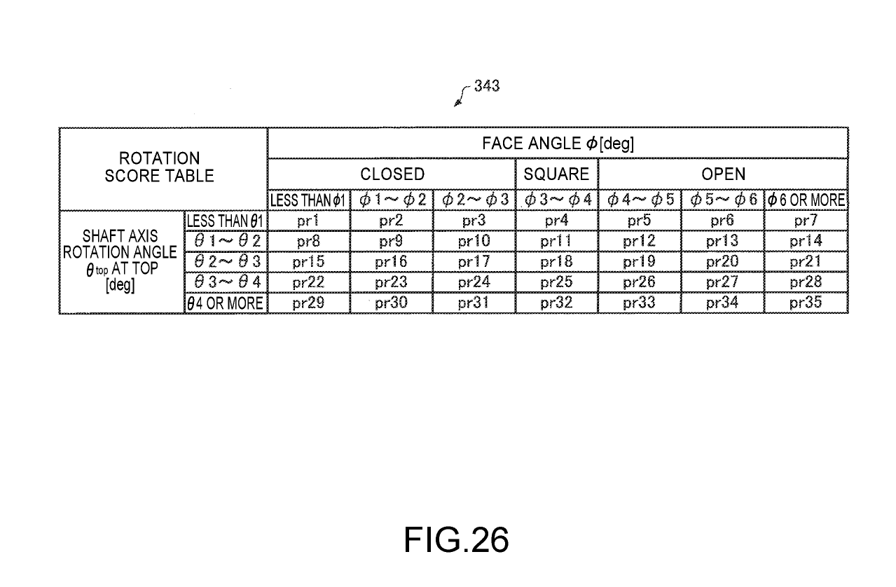

In the present embodiment, as illustrated in FIG. 26, the rotation score table 343 defines a score for each combination of a range in which the shaft axis rotation angle θₜₒₚ at top is included and a range in which the face angle φ is included. In the example illustrated in FIG. 26, a range in which the shaft axis rotation angle θₜₒₚ at top is included is classified into five ranges such as “less than θ1”, “θ1 or more and less than θ2”, “θ2 or more and less than θ3”, “θ3 or more and less than θ4”, and “θ4 or more”. A range in which the face angle φ is included is classified into seven ranges such as “less than φ1”, “φ1 or more and less than φ2”, “φ2 or more and less than φ3”, “φ3 or more and less than φ4”, “φ4 or more and less than φ5”, “φ5 or more and less than φ6”, and “φ6 or more”. For example, in a case where the shaft axis rotation angle θₜₒₚ at top is included in the range of “less than θ1”, and the face angle φ is included in the range of “less than φ1”, a score is pr1. Each of scores pr1 to pr35 illustrated in FIG. 26 is any one of, for example, 1 point to 5 points.

The score calculation portion 311 may calculate a lower score as a hit ball predicted on the basis of a relationship between the shaft axis rotation angle θₜₒₚ at top and the face angle φ becomes more easily curved.

For example, since the face surface of the golf club 3 is considerably open in a state where the shaft axis rotation angle θₜₒₚ at top is extremely large, it is expected that the face surface is not completely returned to a square at impact, and thus a hit ball is easily curved. A state in which the face angle φ is extremely large is a state in which the face surface at impact is considerably open, and a state in which the face angle φ is extremely small (a negative state in which an absolute value thereof is great) is a state in which the face surface at impact is considerably closed. In either state, it is expected that a hit ball is easily curved. In other words, for example, in a case where the shaft axis rotation angle θₜₒₚ is included in the range of “θ4 or more”, and the face angle φ is included in the range of “less than φ1” or “φ6 or more”, it is expected that a hit ball is easily curved, and thus the score calculation portion 311 calculates a relatively low score. Therefore, in the example illustrated in FIG. 26, pr29 or pr35 may be 1 point which is the lowest score, for example, among 1 point to 5 points.

For example, if the shaft axis rotation angle θₜₒₚ at top is small, it is expected that the face surface is completely returned to the square at impact, and thus a hit ball easily flies straight. If the face angle φ is close to 0°, the face surface at impact is close to the square, and thus it is expected that a hit ball easily flies straight. In other words, in a case where the shaft axis rotation angle θₜₒₚ is included in the range of “less than θ1”, and the face angle φ is included in the range of “φ3 or more and less than φ4”, it is expected that a hit ball easily flies straight, and thus the score calculation portion 311 calculates a relatively high score (for example, 5 points maximum). Therefore, in the example illustrated in FIG. 26, pr4 may be 5 points which is the highest score, for example, among 1 point to 5 points.

### 1-5-3. Calculation of Score of “Impact” Item

The score calculation portion 311 calculates a score of the “impact” item depending on in which range among a plurality of ranges each of the club path (incidence angle) ψ and the relative face angle η is included. Specifically, first, the score calculation portion 311 determines whether or not in which range the club path (incidence angle) ψ included in data (target diagnosis input data) regarding a swing is included. The score calculation portion 311 calculates the relative face angle q by subtracting the club path (incidence angle) ψ from the face angle φ included in the data (diagnosis target input data) regarding the swing (refer to FIG. 18), and determines in which range the relative face angle t is included. Next, the score calculation portion 311 calculates a score corresponding to a determination result by referring to the impact score table 344.

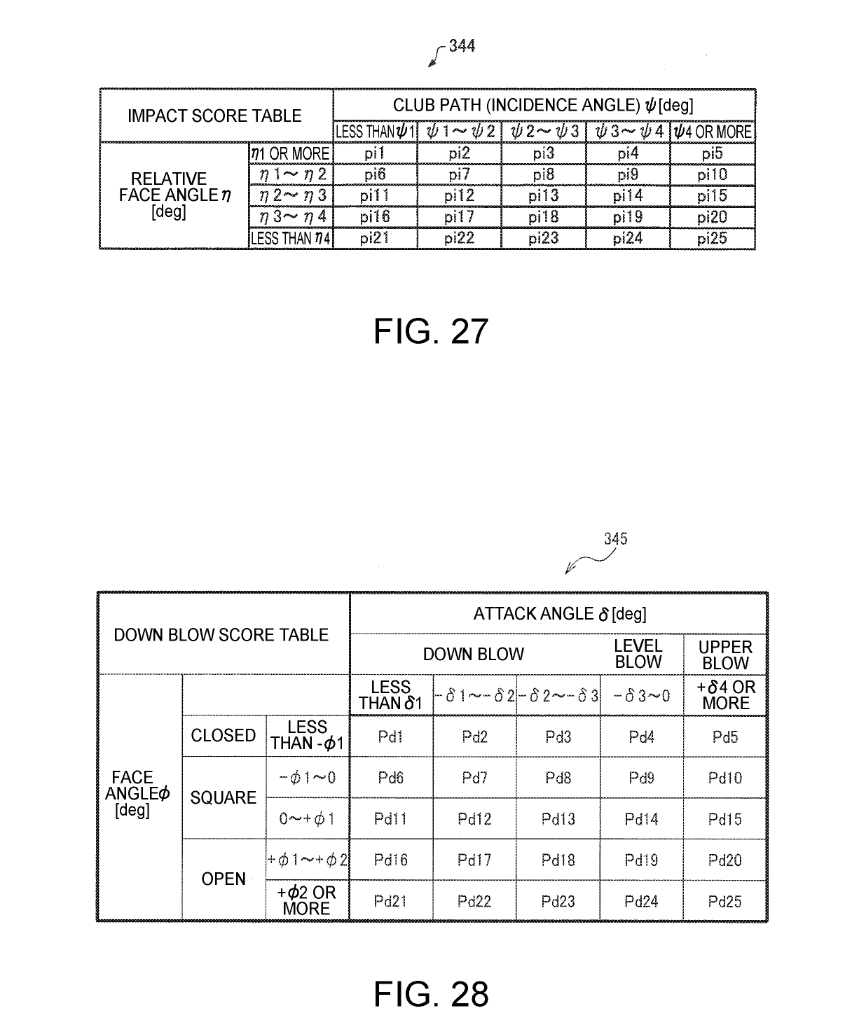

In the present embodiment, as illustrated in FIG. 27, the impact score table 344 defines a score for each combination of a range in which the relative face angle η is included and a range in which the club path (incidence angle) ψ is included. In the example illustrated in FIG. 27, a range in which the relative face angle η is included is classified into five ranges such as “η1 or more”, “less than η1 and η2 or more”, “less than η2 and η3 or more”, “less than η3 and η4 or more”, and “less than η4”. A range in which the club path (incidence angle) ψ is included is classified into five ranges such as “less than ψ1”, “ψ1 or more and less than ψ2”, “ψ2 or more and less than ψ3”, “ψ3 or more and less than ψ4”, and “ψ4 or more”. For example, in a case where the relative face angle η is included in the range of “η1 or more”, and the club path (incidence angle) ψ is included in the range of “less than ψ1”, a score is pi1. Each of scores pi1 to pi25 illustrated in FIG. 27 is any one of, for example, 1 point to 5 points.

The score calculation portion 311 may calculate a lower score as a hit ball predicted on the basis of the club path (incidence angle) ψ and the relative face angle η becomes more easily curved.

For example, a state in which the relative face angle η is extremely large is a state in which the face surface at impact is open, and a state in which the face angle is extremely small (a negative state in which an absolute value thereof is great) is a state in which the face surface at impact is considerably closed. In either state, it is expected that a hit ball is easily curved. For example, in a state in which the club path (incidence angle) ψ is extremely large, a trajectory of the head at impact becomes a considerably inside-out trajectory, and thus it is expected that a hit ball is easily curved. In a state in which the club path (incidence angle) ψ is extremely small (a negative state in which an absolute value thereof is great), a trajectory of the head at impact becomes a considerably outside-in trajectory, and thus it is expected that a hit ball is easily curved. In other words, for example, in a case where the relative face angle η is included in the range of “η1 or more” or “less than η4”, and the club path (incidence angle) ψ is included in the range of “less than ψ1” or “ψ4 or more”, it is expected that a hit ball is easily curved, and thus the score calculation portion 311 calculates a relatively low score. Therefore, in the example illustrated in FIG. 27, pi1, pi5, pi21, and pi25 may be 1 point which is the lowest score, for example, among 1 point to 5 points.

For example, in a case where the relative face angle η is close to 0°, and the club path (incidence angle) ψ is close to 0°, the face surface at impact is close to the square, and a trajectory of the head at impact is nearly straight. Therefore, it is expected that a hit ball easily flies straight. In other words, in a case where the relative face angle η is included in the range of “less than η2 and η3 or more”, and the club path (incidence angle) ψ is included in the range of “ψ2 or more and less than ψ3”, it is expected that a hit ball easily flies straight, and thus the score calculation portion 311 calculates a relatively high score (for example, 5 points maximum). Therefore, in the example illustrated in FIG. 27, pi13 may be 5 points which is the highest score, for example, among 1 point to 5 points.

### 1-5-4. Calculation of Score of “Down Blow” Item

The score calculation portion 311 calculates a score of the “down blow” item depending on in which range among a plurality of ranges each of the attack angle δ and the absolute face angle φ is included in a case where an iron is selected as the golf club 3. Specifically, first, the score calculation portion 311 determines whether or not in which range the attack angle δ illustrated in FIG. 21 is included. The score calculation portion 311 determines whether or not in which range the face angle φ illustrated in FIG. 18 is included. Next, the score calculation portion 311 calculates a score corresponding to a determination result by referring to the down blow score table 345 as illustrated in FIG. 28.

In the present embodiment, as illustrated in FIG. 28, the down blow score table 345 defines a score for each combination of a range in which the attack angle δ is included and a range in which the absolute face angle φ is included. In the example illustrated in FIG. 28, a range in which the attack angle δ is included is classified into five ranges such as “less than −δ1”, “−δ1 or more and less than −δ2”, “−δ2 or more and less than −δ3”, “−δ3 or more and less than 0”, and “+δ4 or more” (where δ1>δ2>δ3 and δ4≈0). A range in which the absolute face angle Q is included is classified into five ranges such as “less than −φ1”, “−φ1 or more and 0 or less”, “more than 0 and less than +φ1”, “+φ1 or more and less than +φ2”, and “+φ2 or more” (where φ1<φ2). For example, in a case where the attack angle δ is included in the range of “less than −δ1”, and the absolute face angle φ is included in the range of “less than −φ1”, a score is pd1.

Here, when a sign of the attack angle (first angle) δ is the second sign (positive), scores pd5, pd10, pd15, pd20, and pd25 may be the lowest score. In this case, an absolute value of the threshold value δ4 may be infinitely small (δ8≈0). As mentioned above, the second sign (positive) of the attack angle (first angle) δ at impact indicates an upper blow in which the lowest point of the club head during a downswing occurs before the impact. In an iron club requiring a down blow, if it is determined that a sign of the attack angle (first angle) δ is the second sign (positive), the lowest score may be calculated, and thus a swing may be evaluated to be bad.

Next, in a case where a sign of the attack angle (first angle) δ is the first sign (negative), and a sign of the absolute face angle (second angle) φ is the fourth sign (positive), if an absolute value of the absolute face angle (second angle) φ is equal to or greater than the first threshold value φ2, scores pd21 to pd24 illustrated in FIG. 28 satisfying this condition may be set to be low. As mentioned above, the first sign (negative) of the attack angle (first angle) δ at impact indicates a down blow in which the lowest point of the club head during a downswing occurs after the impact. If the attack angle (first angle) δ is zero, a true level blow occurs, but a level blow may also be regarded to occur in a case where an absolute value of an attack angle having the first sign (negative) is small. Even in this case, in a case where it is determined that the absolute face angle (second angle) φ is equal to or more than the first threshold value φ2 indicating an excessively open state, a low score may be calculated, and thus a swing may be evaluated to be bad, even if the attack angle (first angle) δ indicates a down blow.

Next, in a case where a sign of the attack angle (first angle) δ is the first sign (negative), if an absolute value of the attack angle (first angle) δ is smaller than a second threshold value δ2, and an absolute value of the absolute face angle (second angle) φ is smaller than the third threshold value φ1, scores pd8, pd9, pd13 and pd14 satisfying this condition may be set to be highest. The case where a sign of the attack angle (first angle) δ is the first sign (negative) indicates a case where a swing using an iron club is an appropriate down blow or a level blow. For example, if an absolute value of the attack angle (first angle) δ is smaller than the second threshold value δ2, it is determined that the attack angle (first angle) δ is in an appropriate range. Similarly, if an absolute value of the absolute face angle (second angle) φ is smaller than the third threshold value φ1, it is also determined that the absolute face angle (second angle) φ is in an appropriate range. In this case, the highest score may be calculated, and thus the swing may be evaluated to be good.

Next, in a case where a sign of the attack angle (first angle) δ is the first sign (negative), and a sign of the absolute face angle (second angle) φ is the fourth sign (positive), if an absolute value of the absolute face angle (second angle) φ is equal to or greater than the third threshold value φ1 and is smaller than the first threshold value φ2, scores pd16 to pd19 satisfying this condition may be set as low scores. The case where a sign of the attack angle (first angle) δ is the first sign (negative) indicates a case where a swing using an iron club is an appropriate down blow or a level blow. The case where a sign of the absolute face angle (second angle) φ is the fourth sign (positive) corresponds to the time at which the face surface is open. In this case, if an absolute value of the absolute face angle (second angle) φ is equal to or greater than the third threshold value φ1 and is smaller than the first threshold value φ2, low scores are set. The scores pd21 to pd24 illustrated in FIG. 28 may be the same as the scores pd16 to pd19 illustrated in FIG. 28.

Next, in a case where a sign of the attack angle (first angle) δ is the first sign (negative), and a sign of the absolute face angle (second angle) φ is the third sign (negative), if an absolute value of the absolute face angle (second angle) φ is equal to or greater than the third threshold value φ1, scores pd1, pd2, pd3 and pd4 illustrated in FIG. 28 satisfying this condition may be set as intermediate scores higher than the low scores. The case where a sign of the first angle corresponding to an attack angle is the first sign (negative) indicates a case where a swing using an iron club is an appropriate down blow or a level blow. The case where a sign of the absolute face angle (second angle) φ is the third sign (negative) corresponds to the time at which a face angle of the head (ball hitting portion) 3b with respect to a target hitting direction at impact indicates a closed state. In this case, even if an absolute value of the absolute face angle (second angle) φ is equal to or greater than the third threshold value φ1, intermediate scores which are higher than the low scores are set.

Next, if an absolute value of the attack angle (first angle) δ is equal to or greater than the fourth threshold value δ1 and is smaller than the second threshold value δ2 in a case where a sign of the attack angle (first angle) δ is the first sign (negative), and if an absolute value of the absolute face angle (second angle) φ is smaller than the third threshold value φ1 in a case where a sign of the absolute face angle (second angle) φ is the third sign (negative), a score pd7 illustrated in FIG. 28 satisfying this condition is set as a score which is lower than the highest score and is higher than the intermediate score. The case where a sign of the first angle corresponding to an attack angle is the first sign (negative) indicates a case where a swing using an iron club is an appropriate down blow. In this case, if an absolute value of the attack angle (first angle) δ is equal to or greater than the fourth threshold value δ1 and is smaller than second threshold value δ2, it can be said that the attack angle (first angle) δ is in a range similar to an appropriate range. The case where a sign of the absolute face angle (second angle) φ is the third sign (negative) corresponds to the time at which a face angle of the head (ball hitting portion) 3b with respect to a target hitting direction at impact indicates a closed state. In this case, if an absolute value of the absolute face angle (second angle) φ is smaller than the third threshold value φ1, a score which is lower than the highest score and is higher than the intermediate score is set.

Next, if an absolute value of the attack angle (first angle) δ is equal to or greater than the fourth threshold value δ1 and is smaller than the second threshold value δ2 in a case where a sign of the attack angle (first angle) δ is the first sign (negative), and if an absolute value of the absolute face angle (second angle) φ is smaller than the third threshold value φ1 in a case where a sign of the absolute face angle (second angle) φ is the fourth sign (positive), a score pd12 illustrated in FIG. 28 satisfying this condition is set as a score which is lower than the highest score and is higher than the intermediate score. The case where a sign of the first angle corresponding to an attack angle is the first sign (negative) indicates a case where a swing using an iron club is an appropriate down blow. In this case, if an absolute value of the attack angle (first angle) δ is equal to or greater than the fourth threshold value δ1 and is smaller than second threshold value δ2, it can be said that the attack angle (first angle) δ is in a range similar to an appropriate range. On the other hand, the case where a sign of the absolute face angle (second angle) φ is the fourth sign (positive) corresponds to the time at which a face angle of the head (ball hitting portion) 3b with respect to a target hitting direction at impact indicates an open state. In this case, if an absolute value of the absolute face angle (second angle) φ is smaller than the third threshold value φ1, a score which is lower than the highest score and is higher than the intermediate score is set.

In the present embodiment, in a case where a sign of the attack angle (first angle) δ is the first sign (negative), and a sign of the absolute face angle (second angle) φ is the fourth sign (positive), a lower score may be calculated as an absolute value of the second angle becomes greater (for example, pd6<pd7<pd8, pd9, pd11<pd12<pd13).

In the present embodiment, in a case where a sign of the attack angle (first angle) δ is the first sign (negative), a higher score may be calculated as an absolute value of the first angle becomes smaller and an absolute value of the second angle becomes smaller (for example, pd2<pd7=pd12<pd8=pd13, and pd7=pd12>pd17).

In the present embodiment, in a case where a sign of the attack angle (first angle) δ is the first sign (negative), and a sign of the absolute face angle (second angle) φ is the third sign (negative), a lower score is calculated as an absolute value of the second angle becomes greater (for example, pd1<pd6, pd2<pd7, pd3<pd8, and pd4<pd9).

### 1-5-5. Calculation of Score of “Upper Blow” Item

The score calculation portion 311 calculates a score of the “upper blow” item depending on in which range among a plurality of ranges each of the attack angle δ and the absolute face angle φ is included in a case where a wood is selected as the golf club 3. Specifically, the score calculation portion 311 calculates a score corresponding to a determination result by referring to the upper blow score table 346, for example, as illustrated in FIG. 29.

Here, FIG. 29 may be created, for example, by changing signs of the attack angle (first angle) δ illustrated in FIG. 28. In other words, since a wood requires an upper blow, if a sign of the attack angle (first angle) δ is the first sign (negative) indicating a down blow, scores pu5, pu10, pu15, pu20 and pu25 satisfying this condition are the lowest score. Also in a case where a sign of the attack angle (first angle) δ is the second sign (positive) indicating an upper blow, if the absolute face angle (second angle) φ indicates an excessive open state (φ≧+φ2), scores pu21 to pu24 satisfying this condition are the lowest score. The scores pu1 to pu25 illustrated in FIG. 29 may be the same as the scores pd1 to pd25 illustrated in FIG. 28 in corresponding numbers. For example, in FIG. 29, the highest score may be set in the range of 0≦δ<δ2 and the range of −φ1<φ<+φ1 (pu8=pu9=pu13=pu14=highest score). In FIGS. 28 and 29, values of δ1 to δ4 or values of φ1 and φ2 may be the same as or different from each other. In FIGS. 28 and 29, values of pd1 to pd25 and values of pu1 to pu25 may be the same as or different from each other.

### 1-5-6. Calculation of Score of “Swing Efficiency” Item

The score calculation portion 311 calculates a score of the “swing efficiency” item depending on in which range among a plurality of ranges each of the grip deceleration ratio R_{V} and the grip deceleration time ratio R_{T} is included. Specifically, first, the score calculation portion 311 determines whether or not in which range each of the grip deceleration ratio R_{V} and the grip deceleration time ratio R_{Y} included in data (target diagnosis input data) regarding a swing is included. Next, the score calculation portion 311 calculates a score corresponding to a determination result by referring to the swing efficiency score table 347.

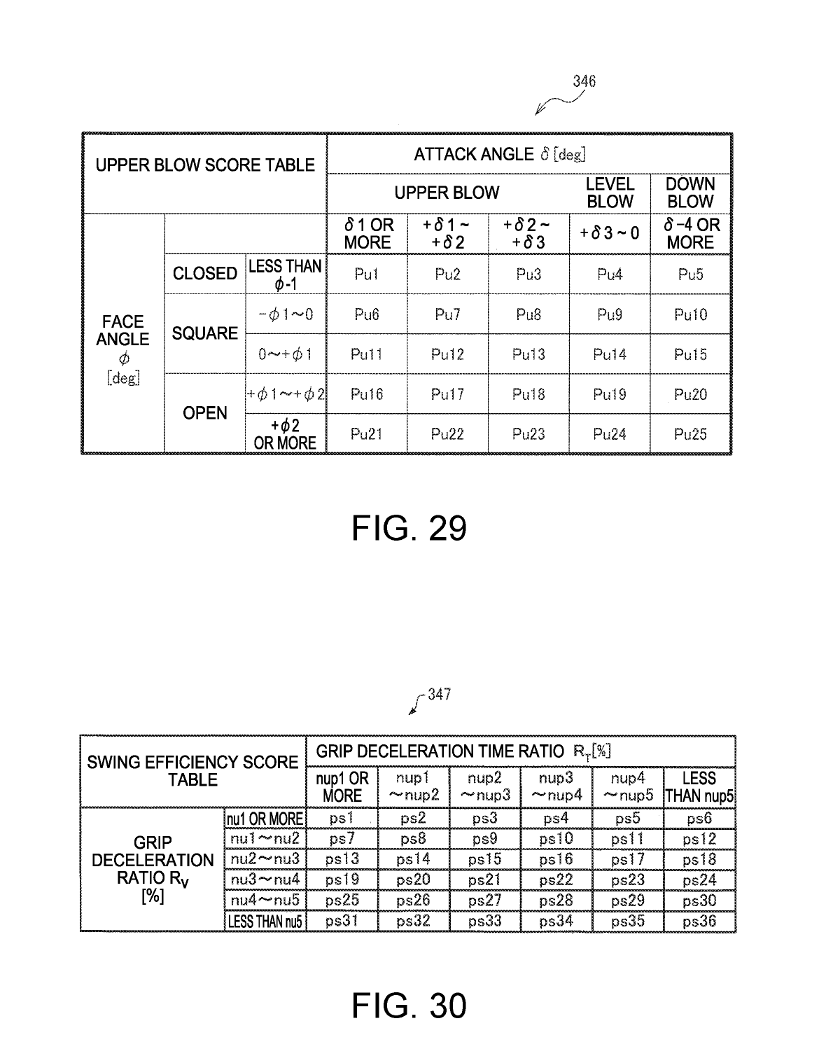

In the present embodiment, as illustrated in FIG. 30, the swing efficiency score table 347 defines a score for each combination of a range in which the grip deceleration ratio R_{V} is included and a range in which the grip deceleration time ratio R_{T} is included. In the example illustrated in FIG. 30, a range in which the grip deceleration ratio R_{V} is included is classified into six ranges such as “nu1 or more”, “less than nu1 and nu2 or more”, “less than nu2 and nu3 or more”, “less than nu3 and nu4 or more”, “less than nu4 and nu5 or more”, and “less than nu5”. A range in which the grip deceleration time ratio R_{T} is included is classified into six ranges such as “nup1 or more”, “less than nup1 and nup2 or more”, “less than nup2 and nup3 or more”, “less than nup3 and nup4 or more”, “less than nup4 and nup5 or more”, and “less than nup5”. For example, in a case where the grip deceleration ratio R_{V} is included in the range of “nu1 or more”, and the grip deceleration time ratio R_{T} is included in the range of “nup1 or more”, a score is ps1. Each of scores ps1 to ps36 illustrated in FIG. 30 is any one of, for example, 1 point to 5 points.

The score calculation portion 311 may calculate a higher score as swing efficiency predicted on the basis of a relationship between the grip deceleration ratio R_{V} and the grip deceleration time ratio R_{T} becomes higher.

It is considered in a golf swing that, when the head is accelerated, the arms are decelerated by reducing forces of the arms in a downswing, and thus natural rotation of the golf club occurs, so that the shaft is accelerated. A tendency for the natural rotation of the golf club to occur can be understood depending on to what extent a speed of the grip is decelerated during a downswing. Therefore, it is expected that a highly efficient swing using natural rotation of the golf club can be realized as the grip deceleration ratio R_{V} becomes higher. However, if a timing at which natural rotation of the golf club occurs is close to an impact timing, that is, the grip deceleration time ratio R_{T} is low, impact occurs in a state in which the natural rotation of the golf club cannot be sufficiently used, and thus it cannot necessarily be said that a highly efficient swing is performed. In other words, for example, in a case where the grip deceleration ratio R_{V} is included in the range of “nu1 or more”, and the grip deceleration time ratio R_{T} is included in the range of “nup1 or more”, it is expected that swing efficiency is high, and thus the score calculation portion 311 calculates a relatively high score. For example, in a case where the grip deceleration ratio R_{V} is included in the range of “less than nu5”, and the grip deceleration time ratio R_{T} is included in the range of “less than nup5”, it is expected that swing efficiency is low, and thus the score calculation portion 311 calculates a relatively low score. Therefore, in the example illustrated in FIG. 30, ps1 may be 5 points which is the highest score, for example, among 1 point to 5 points, and ps36 may be 1 point which is the lowest score, for example, among 1 point to 5 points.

Here, in the score tables illustrated in FIGS. 26 to 30, a level is calculated on the basis of the first index and the second index. As mentioned above, a level can be calculated through positioning of a swing in a two-axis coordinate system formed of the first index and the second index, and thus a swing of exercise equipment at impact can be objectively determined.

A score is added to each area in advance on the basis of a relationship between the first index and the second index, and thus a lookup table can be used. A score can be specified on the basis of the first index and the second index using the lookup table, and the score can be calculated as a level. As mentioned above, since a swing is calculated as a score on the basis of a relationship between the first index and the second index using the lookup table, it is possible to easily and appropriately perform an objective determination on a swing of exercise equipment at impact.

### 1-5-7. Calculation of Total Score

The score calculation portion 311 calculates a total score on the basis of the score of the “V zone” item, the score of the “rotation” item, the score of the “impact” item, the score of the “down blow” or “upper blow” item, and the score of the “swing efficiency” item.

For example, in a case where a score of each item is 5 points maximum, if a maximum of a total score is 100 points, the score calculation portion 311 may multiply the score of each item by 4 so that 20 points maximum is obtained, and may add all the scores together so as to calculate a total score. In the swing diagnosis screen illustrated in FIG. 9, a score of 5 points maximum of each item is displayed as a radar chart, and the score of each item is multiplied by 4, and 64 points obtained by adding all the scores together is a total score.

For example, the score calculation portion 311 may increase a weight of a highly important item in diagnosis (evaluation) of a swing and may add scores of the items together so as to calculate a total score.

### 1-5-8. Procedures of Swing Diagnosis Process (Swing Diagnosis Method)

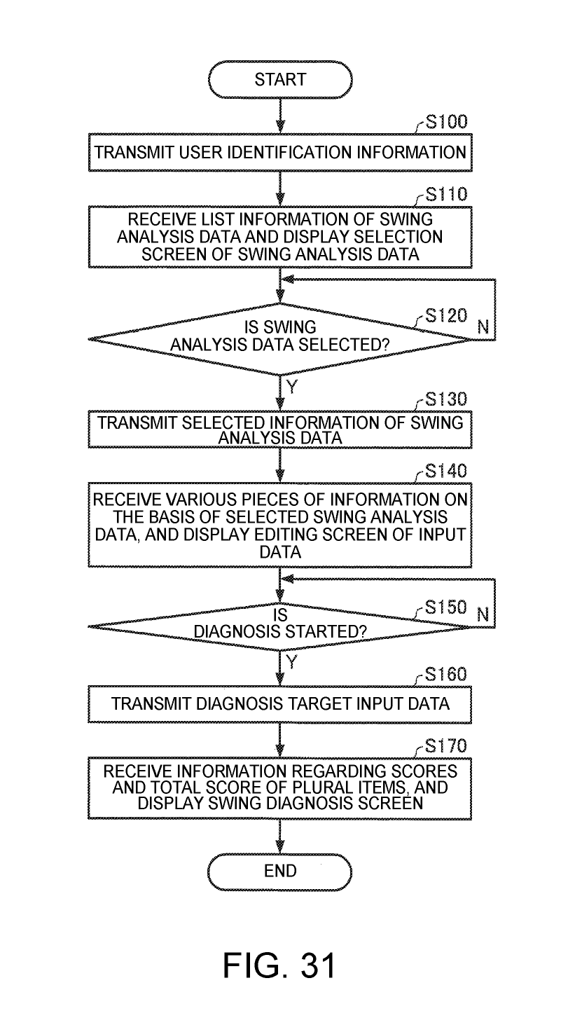

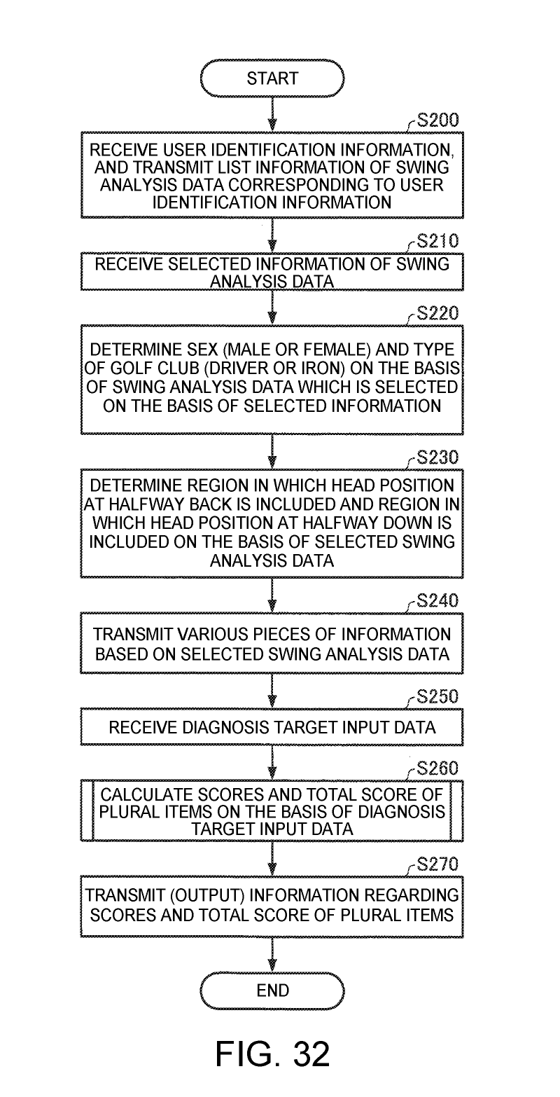

FIG. 31 is a flowchart illustrating examples of procedures of a process performed by the processing section 21 of the swing analysis apparatus 20 in relation to the swing diagnosis process. FIG. 32 is a flowchart illustrating examples of procedures of the swing diagnosis process (swing diagnosis method) performed by the processing section 31 of the swing diagnosis apparatus 30. The processing section 31 (an example of a computer) of the swing diagnosis apparatus 30 performs the swing diagnosis process, for example, according to the procedures of the flowchart of FIG. 32 by executing the swing diagnosis program 340 stored in the storage section 34. Hereinafter, the flowcharts of FIGS. 31 and 32 will be described.

First, the processing section 21 of the swing analysis apparatus 20 transmits user identification information allocated to the user 2, to the swing diagnosis apparatus 30 (step S100 in FIG. 31).

Next, the processing section 31 of the swing diagnosis apparatus 30 receives the user identification information, and transmits list information of the swing analysis data 248 corresponding to the user identification information (step S200 in FIG. 32).

Next, the processing section 21 of the swing analysis apparatus 20 receives the list information of the swing analysis data 248, and displays a selection screen (FIG. 7) of the swing analysis data on the display section 25 (step S110 in FIG. 31).

The processing section 21 of the swing analysis apparatus 20 waits for the swing analysis data 248 to be selected on the selection screen of the swing analysis data (N in step S120 in FIG. 31), and transmits selected information of the swing analysis data to the swing diagnosis apparatus 30 (step S130 in FIG. 31) if the information is selected (Y in step S120 in FIG. 31).

Next, the processing section 31 of the swing diagnosis apparatus 30 receives the selected information of the swing analysis data (step S210 in FIG. 32), and determines the sex (a male or a female) and the type of golf club (a driver or an iron) on the basis of the swing analysis data 248 which is selected on the basis of the selected information (step S220 in FIG. 32).

The processing section 31 of the swing diagnosis apparatus 30 determines a region in which a head position at halfway back is included and a region in which a head position at halfway down is included on the basis of the selected swing analysis data 248 (step S230 in FIG. 32).

Next, the processing section 31 of the swing diagnosis apparatus 30 transmits various pieces of information based on the selected swing analysis data (step S240 in FIG. 32). The various pieces of information based on the selected swing analysis data include the determination result in step S220, the determination result in step S230, and information regarding some index values (the face angle φ, the attack angle δ, the club path (incidence angle) ψ, the shaft axis rotation angle θₜₒₚ at top, the head speed, the grip deceleration ratio R_{V}, and the grip deceleration time ratio R_{T}) included in the selected swing analysis data 248.

Next, the processing section 21 of the swing analysis apparatus 20 receives the various pieces of information based on the selected swing analysis data 248, and displays an editing screen (FIG. 8) of input data on the display section 25 (step S140 in FIG. 31).

The processing section 21 of the swing analysis apparatus 20 waits for a diagnosis starting operation to be performed on the editing screen of input data (N in step S150 in FIG. 31), and transmits diagnosis target input data to the swing diagnosis apparatus 30 (step S160 in FIG. 31) if the diagnosis starting operation is performed (Y in step S150 in FIG. 31).

Next, the processing section 31 of the swing diagnosis apparatus 30 receives the diagnosis target input data (step S250 in FIG. 32), and calculates scores and a total score of a plurality of items on the basis of the diagnosis target input data (step S260 in FIG. 32).

Next, the processing section 31 of the swing diagnosis apparatus 30 transmits (outputs) information regarding the scores and the total score of the plurality of items to the swing analysis apparatus 20 (step S270 in FIG. 32), and finishes the swing diagnosis process.

The processing section 21 of the swing analysis apparatus 20 receives the information regarding the scores and the total score of the plurality of items, displays the swing diagnosis screen (FIG. 9) on the display section 25 (step S170 in FIG. 31), and finishes the process.

In the flowchart of FIG. 31, order of the respective steps may be changed as appropriate within an allowable range, some of the steps may be omitted or changed, and other steps may be added thereto. Similarly, in the flowchart of FIG. 32, order of the respective steps may be changed as appropriate within an allowable range, some of the steps may be omitted or changed, and other steps may be added thereto.

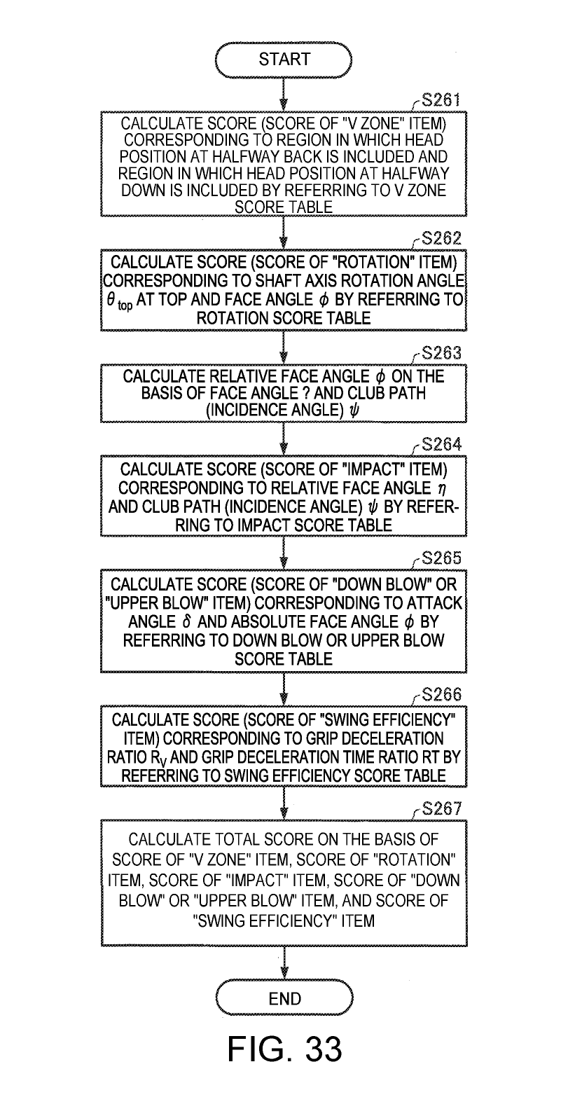

FIG. 33 is a flowchart illustrating examples of procedures of a process (step S260 in FIG. 32) of calculating scores and a total score of a plurality of items in the processing section 31 (score calculation portion 311) of the swing diagnosis apparatus 30. Hereinafter, the flowchart of FIG. 33 will be described.

First, the processing section 31 calculates a score (a score of the “V zone” item) corresponding to a region in which a head position at halfway back is included and a region in which a head position at halfway down is included by referring to the V zone score table 342 stored in the storage section 34 (step S261).

Next, the processing section 31 calculates a score (a score of the “rotation” item) corresponding to the shaft axis rotation angle θₜₒₚ at top and the face angle φ by referring to the rotation score table 343 stored in the storage section 34 (step S262).

Next, the processing section 31 calculates the relative face angle t on the basis of the face angle and the club path (incidence angle) p (step S263).

Next, the processing section 31 calculates a score (a score of the “impact” item) corresponding to the relative face angle η and the club path (incidence angle) ψ by referring to the impact score table 344 stored in the storage section 34 (step S264).

Next, if an iron is selected as the golf club 3, the processing section 31 calculates a score (a score of the “down blow” item) corresponding to the attack angle δ and the absolute face angle φ by referring to the down blow score table 345 stored in the storage section 34 (step S265). Alternatively, if a wood is selected as the golf club 3, the processing section 31 calculates a score (a score of the “upper blow” item) corresponding to the attack angle δ and the absolute face angle φ by referring to the upper blow score table 346 stored in the storage section 34 (step S265).

Next, the processing section 31 calculates a score (a score of the “swing efficiency” item) corresponding to the grip deceleration ratio R_{V} and the grip deceleration time ratio R_{T} by referring to the swing efficiency score table 347 stored in the storage section 34 (step S266).

Finally, the processing section 31 calculates a total score on the basis of the score of the “V zone” item calculated in step S261, the score of the “rotation” item calculated in step S262, the score of the “impact” item calculated in step S264, the score of the “down blow” or “upper blow” item calculated in step S265, and the score of the “swing efficiency” item calculated in step S266 (step S267).

### 1-5-9. Swing Diagnosis Screen and Lesson Screen

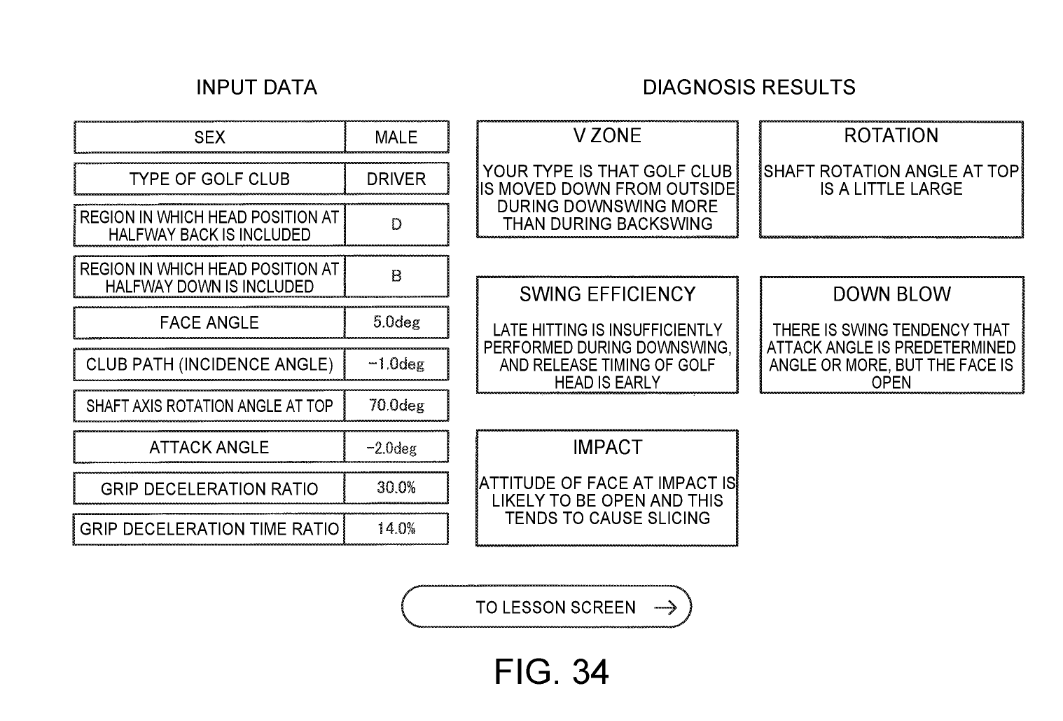

A swing diagnosis screen illustrated in FIG. 34 is a screen in a hierarchy which is different from that of the screen illustrated in FIG. 9. The swing diagnosis screen illustrated in FIG. 34 includes input data information on a left part thereof. The input data information is input data at the time of the diagnosis starting button being pressed in the input data editing screen illustrated in FIG. 8, that is, data information used for diagnosis of the swing (that is, generation of diagnosis information for each item) in the swing diagnosis apparatus 30. The swing diagnosis screen illustrated in FIG. 34 includes a diagnosis result of each item on a right part thereof. The diagnosis result of each item is to represent (notify or provide) a swing type, a weak point (weakness), a strong point, and the like regarding the item, for example, in text. FIG. 34 illustrates an example in which a diagnosis result of each item is represented (notified or provided) in text, but representation aspects (a notification aspect or a provision aspect) other than text, such as an icon, a still image, a moving image, and a voice may be used instead of the text, a combination of two or more representation aspects (a notification aspect or a provision aspect) may be used. The swing diagnosis screen illustrated in FIG. 34 includes a button (in FIG. 34, a button image with text such as “to lesson screen”) for switching to a lesson screen on a lower part thereof. If the user 2 presses the switching button, the swing diagnosis screen is changed to a lesson screen.

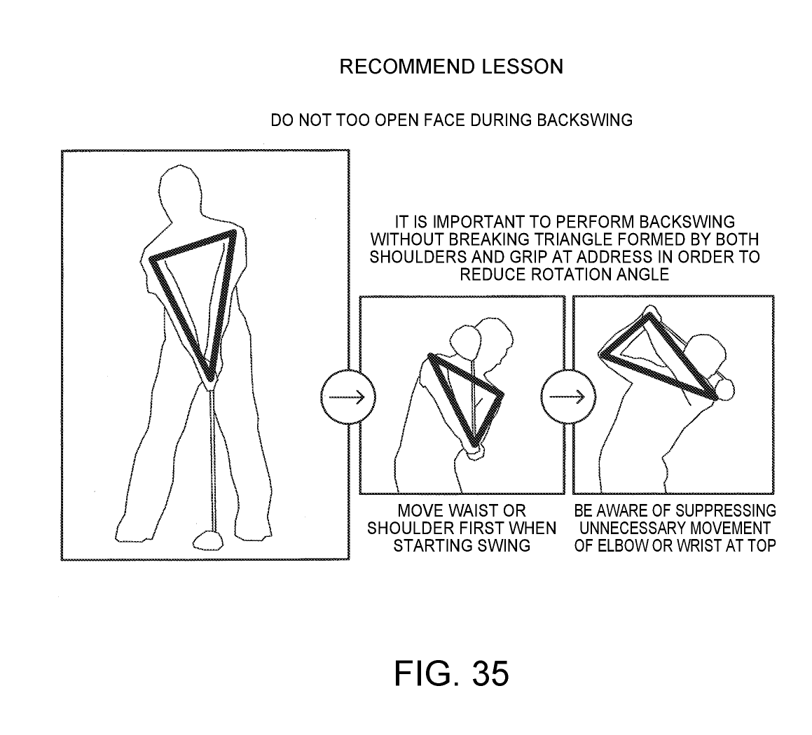

The lesson screen illustrated in FIG. 35 includes, for example, one or a plurality of lesson methods (advice) suitable for improving (overcoming) a weak point shown in a diagnosis result of an item with the lowest level. The lesson method is represented by, for example, a combination of text and a still image. FIG. 35 illustrates an example in which the lesson method (advice) is represented (notified or provided) by a combination of text and a still image, but representation aspects other than the text or the still image, such as an icon, a moving image, and a voice may be used instead of the combination, and a single representation aspect or a combination of one or three or more representation aspects may be used.

On the swing diagnosis screen illustrated in FIG. 34, as a diagnosis result of the “V zone” item, the content that “the golf club is moved down from the outside during a downswing more than during a backswing” is displayed. As a diagnosis result of the “swing efficiency” item, the content that “late hitting is insufficiently performed during a downswing, and the release timing of the club head is early” is displayed. As a diagnosis result of the “impact” item, the content that “the attitude of the face at impact is likely to be open and this tends to cause slicing” is displayed. As a diagnosis result of the “rotation” item, the content that “the shaft rotation angle at top is a little large” is displayed. As a diagnosis result of the “down blow” item, the content that “there is a swing tendency that the attack angle is a predetermined angle or more, but the face is open” is displayed.

For example, a diagnosis result corresponding to each item may be formed in advance in each region (for each score) of the score tables illustrated in FIGS. 26 to 30. For example, in the “down blow” item, pd5, pd10, pd15, pd20, and pd25 as the lowest score are correlated with a diagnosis result that “a swing tends to be performed from a level blow with a small attack angle to an upper blow; the swing is late since your body is opened during a downswing, or the swing axis is moved in a flight line direction; if you hits a ball while lowering the right shoulder in order to cover the swing delay, the left arm also rises so as to cause duff and an upper blow; thus, if you stops the weight shift or the lower body-led consciousness to prepare for early impact, the swing delay is corrected; and aim at a down blow swing by normally paying attention to NRT or NU numerical values so as to decelerate the grip end”.

The low scores pd16 to pd19 are correlated with a diagnosis result that “there is a swing tendency that the attack angle is a predetermined angle or more, but the face is open; since the weight shift to the left or lower body leading is strong, the upper body moves to the left during a downswing, and thus there is a tendency that a down blow increases or the face is unlikely to be closed; and perform a swing while being aware of keeping a head position on the right side of the body during a downswing, so as to maintain a head position at address, thereby achieving appropriate attack angle and face angle”.

The intermediate scores pd1 to pd4 similar to the low scores are correlated with a diagnosis result that “there is a swing tendency that the attack angle is a predetermined angle or more, but the face angle is not stable; the face is closed or open at impact, and thus a ball tends to fly along a curved path, such as a hook or a slice; ball hitting is stabilized by removing consciousness of hand swing and being aware of smooth weight shift or lower body leading; and since appropriate ball hitting is performed by taking the balance between movement of the body and movement of the arms, perform a swing while thinking about the balance between movement of the lower body and movement of the upper body”.

Similarly, the lesson screen illustrated in FIG. 35 may also be formed in advance in each region (for each score) of the score tables illustrated in FIGS. 26 to 30. Here, the user 2 may select and display lesson screens corresponding to scores of the five items. A lesson screen corresponding to the lowest score in the five items may be preferentially displayed. In this case, if the lowest scores of a plurality of items are the same as each other, for example, the lesson screens may be displayed according to priority order of the “V zone” item, the “rotation” item, the “impact” item, the “down blow” or “upper blow” item, and the “swing efficiency” item.

### 2. Modification Examples

The invention is not limited to the present embodiment, and may be variously modified within the scope of the spirit of the invention. For example, a plurality of sensor units 10 may be attached to the golf club 3 or parts such as the arms or the shoulders of the user 2, and the swing analysis portion 211 may perform a swing analysis process using measured data from the plurality of sensor units 10.

In the embodiment, the swing analysis portion 211 calculates the third line segment 53 which is a third axis and the Hogan plane HP using the physical information of the user 2, but a line segment and a plane obtained by rotating the second line segment 52 which is a second axis and the shaft plane SP by a predetermined first angle β (for example, 30°) about the X axis, respectively, may be used as the third line segment 53 and the Hogan plane HP.

In the embodiment, the swing analysis portion 211 detects impact using the square root of the square sum as shown in Equation (2) as a combined value of three-axis angular velocities measured by the sensor unit, but, as a combined value of three-axis angular velocities, for example, a square sum of three-axis angular velocities, a sum or an average of three-axis angular velocities, or the product of three-axis angular velocities may be used. Instead of a combined value of three-axis angular velocities, a combined value of three-axis accelerations such as a square sum or a square root of three-axis accelerations, a sum or an average value of three-axis accelerations, or the product of three-axis accelerations may be used.

In the embodiment, the score calculation portion 311 may calculate scores and a total score of a plurality of items on the basis of the selected swing analysis data 248 without displaying the input data editing screen as illustrated in FIG. 8. The score calculation portion 311 may calculate scores and a total score of a plurality of items on the basis of input data (for example, all indexes are manually input data) in which all values of indexes indicating features of a swing are pseudo-values.

In the embodiment, the score calculation portion 311 calculates scores of five items including the “V zone” item, the “rotation” item, the “impact” item, the “down blow” or “upper blow” item, and the “swing efficiency” item, but may not calculate scores of some of the items, and may calculate scores of other items. In the present embodiment, the score calculation portion 311 calculates a total score, but may not calculate a total score.

In the embodiment, the score calculation portion 311 calculates scores of a plurality of items using various score tables, but may use equations instead of the score tables.

In the embodiment, the score calculation portion 311 may also function as the swing analysis portion 211, and may perform a swing diagnosis process (a swing analysis process and a score calculation process) including the swing analysis process on the basis of measured data (an output signal from an inertial sensor) from the sensor unit 10, which is data regarding a swing.

In the embodiment, the whole or a part (display section) of the motion analysis apparatus may be configured using a head mounted display (HMD) as a display destination of a determination result (diagnosis result).

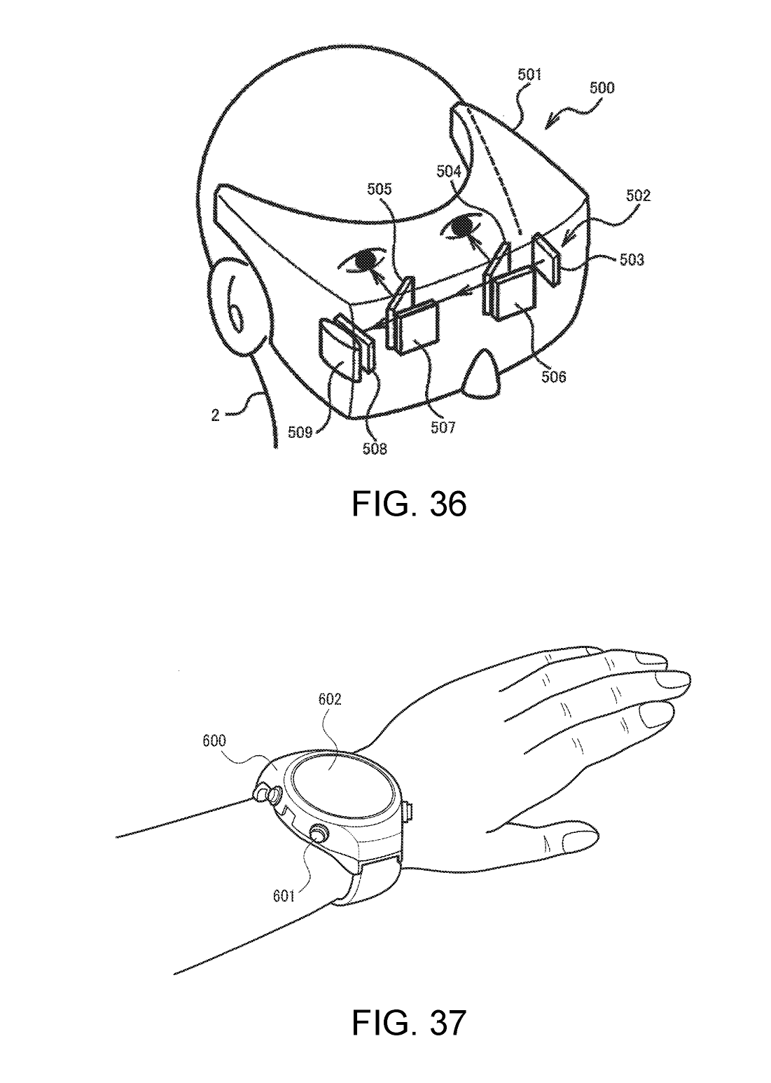

FIG. 36 is a diagram illustrating an example of a head mounted display (HMD).

As illustrated in FIG. 36, an HMD 500 includes a spectacle main body 501 mounted on the head of the user 2. The spectacle main body 501 is provided with a display section 502. The display section 502 integrates a light beam emitted from an image display unit 503 with a light beam directed toward the eyes of the user 2 from the external world, and thus overlaps a virtual image on the image display unit 503 with a real image of the external world viewed from the user 2.

The display section 502 is provided with, for example, the image display unit 503 such as an liquid crystal display (LCD), a first beam splitter 504, a second beam splitter 505, a first concave reflection mirror 506, a second concave reflection mirror 507, a shutter 508, and a convex lens 509.

The first beam splitter 504 is disposed on the front side of the left eye of the user 2, and partially transmits and partially reflects light emitted from the image display unit 503.

The second beam splitter 505 is disposed on the front side of the right eye of the user 2, and partially transmits and partially reflects light which is partially transmitted from the first beam splitter 504.

The first concave reflection mirror 506, which is disposed in front of the first beam splitter 504, partially reflects the partially reflected light from the first beam splitter 504 so as to transmit the light through the first beam splitter 504, and thus guides the light to the left eye of the user 2.

The second concave reflection mirror 507, which is disposed in front of the second beam splitter 505, partially reflects the partially reflected light from the second beam splitter 505 so as to transmit the light through the second beam splitter 505, and thus guides the light to the right eye of the user 2.

The convex lens 509 guides partially transmitted light from the second beam splitter 505 to the outside of the HMD 500 when the shutter 508 is opened.

According to the HMD 500, the user 2 can understand necessary information such as a swing type thereof without holding the swing analysis apparatus 20 with the hands.

Alternatively, in the embodiment, the whole or a part (display section) of the motion analysis apparatus may be configured using a wrist type terminal as a display destination of a determination result (diagnosis result). FIG. 36 illustrates a wrist type terminal 600 mounted on the wrist of the user 2, and the wrist type terminal 600 includes an operation section 601 and a display section 602.

The entire disclosure of Japanese Patent Application No. 2016-006347 filed Jan. 15, 2016 is expressly incorporated by reference herein.

What is claimed is:

1. A motion analysis method comprising:
calculating a level of a swing using an output from an inertial sensor on the basis of a relationship between a first angle formed between a tangential direction of a swing trajectory of a ball hitting portion of an exercise equipment at impact and a target hitting direction, and a second angle formed between a direction orthogonal to a hitting surface of the ball hitting portion at the impact and the target hitting direction.

2. The motion analysis method according to claim 1,
wherein, in a case where an index related to the first angle is a first index, and an index related to the second angle is a second index, the level is calculated on the basis of the first index and the second index.

3. The motion analysis method according to claim 2,
wherein a score is specified using the first angle and the second angle calculated through measurement on the basis of a table in which a score is added to region in advance according to a relationship between the first index and the second index, and the score is calculated as the level.

4. The motion analysis method according to claim 3,
wherein, in a case where the target hitting direction is set to a +X direction of an X axis, a direction opposite to the gravitational direction is set to a +Z direction of a Z axis, and a direction orthogonal to the X axis and the Z axis is set to be along a Y axis; in a case where, when the Y axis is a rotation axis, a direction in which +Z of the Z axis rotates in the +X direction of the X axis is defined as a first sign, and a sign reverse to the first sign is defined as a second sign, the first and second signs being related to the first angle; and in a case where, when the Z axis is a rotation axis, a direction in which +Y of the Y axis rotates in the +X direction of the X axis is defined as a third sign, and a sign reverse to the third sign is defined as a fourth sign, the third and fourth signs being related to the second angle, in the table, a score is set for region in a coordinate system having the first index and the second index as two axes orthogonal to each other, and
wherein a score added to the region specified by the first angle and the second angle which are calculated through the measurement is output.

5. The motion analysis method according to claim 4,
wherein the first sign is a negative sign, the second sign is a positive sign, the third sign is a negative sign, and the fourth sign is a positive sign.

6. The motion analysis method according to claim 4,
wherein, in a case where a sign of the first angle is the second sign, the lowest score is calculated.

7. The motion analysis method according to claim 4,
wherein, in a case where a sign of the first angle is the first sign, and a sign of the second angle is the fourth sign, a lower score is calculated as an absolute value of the second angle becomes greater.

8. The motion analysis method according to claim 4,
wherein, in a case where a sign of the first angle is the first sign, a higher score is calculated as an absolute value of the first angle becomes smaller, and an absolute value of the second angle becomes smaller.

9. The motion analysis method according to claim 4,
wherein, in a case where a sign of the first angle is the first sign, and a sign of the second angle is the third sign, a lower score is calculated as an absolute value of the second angle becomes greater.

10. The motion analysis method according to claim 1, further comprising:
outputting information regarding the level.

11. The motion analysis method according to claim 1, further comprising:
performing diagnosis on the level; and
outputting diagnosis information based on the diagnosis.

12. The motion analysis method according to claim 11, further comprising:
outputting a practice method on the basis of the diagnosis information.

13. A recording medium recording a motion analysis program causing a computer to execute:
a procedure of calculating a level of a swing using an output from an inertial sensor on the basis of a relationship between a first angle formed between a tangential direction of a swing trajectory of a ball hitting portion of an exercise equipment at impact and a target hitting direction, and a second angle formed between a direction orthogonal to a hitting surface of the ball hitting portion at the impact and the target hitting direction.

14. A motion analysis apparatus comprising:
a first angle calculation unit that calculates a first angle formed between a tangential direction of a swing trajectory of a ball hitting portion of an exercise equipment at impact and a target hitting direction, using an output from an inertial sensor which measures a swing of the exercise equipment;
a second angle calculation unit that calculates a second angle formed between a direction orthogonal to a hitting surface of the ball hitting portion at the impact and the target hitting direction using an output from the inertial sensor; and
a level calculation unit that calculates a level of the swing on the basis of a relationship between the first angle and the second angle.

15. The motion analysis apparatus according to claim 14,
wherein, in a case where an index related to the first angle is a first index, and an index related to the second angle is a second index, the level calculation unit calculates the level on the basis of the first index and the second index.

16. The motion analysis apparatus according to claim 15,
wherein the level calculation unit specifies a score using the first angle and the second angle calculated through measurement on the basis of a table in which a score is added to region in advance according to a relationship between the first index and the second index, and calculates the score as the level.

17. The motion analysis apparatus according to claim 16,
wherein, in a case where the target hitting direction is set to a +X direction of an X axis, a direction opposite to the gravitational direction is set to a +Z direction of a Z axis, and a direction orthogonal to the X axis and the Z axis is set to be along a Y axis; in a case where, when the Y axis is a rotation axis, a direction in which +Z of the Z axis rotates in the +X direction of the X axis is defined as a first sign, and a sign reverse to the first sign is defined as a second sign, the first and second signs being related to the first angle; and in a case where, when the Z axis is a rotation axis, a direction in which +Y of the Y axis rotates in the +X direction of the X axis is defined as a third sign, and a sign reverse to the third sign is defined as a fourth sign, the third and fourth signs being related to the second angle, in the table, a score is set for region in a coordinate system having the first index and the second index as two axes orthogonal to each other, and
wherein the motion analysis apparatus further includes an output unit that outputs a score added to the region specified by the first angle and the second angle which are calculated through the measurement.

18. The motion analysis method according to claim 17, wherein the first sign is a negative sign, the second sign is a positive sign, the third sign is a negative sign, and the fourth sign is a positive sign.

19. A motion analysis system comprising:
the motion analysis apparatus according to claim 14; and
an inertial sensor.
